(19) United States
(12) Patent Application Publication
(10) Pub. No.: US 2008/0300936 A1
(43) Pub. Date: Dec. 4, 2008

(54) MARKET OVERSIGHT FACILITY FOR ENVIRONMENTALLY RELEVANT ITEMS

(76) Inventors: Reiner F.H. Musier, Morgan Hill, CA (US); John M. Melby, San Diego, CA (US); Robert B. Shults, Houston, TX (US); Sakis L. Asteriadis, New York, NY (US); Hung A. Chau, San Jose, CA (US); Michael Heyeck, Sunnyvale, CA (US)

Correspondence Address: STRATEGIC PATENTS P.C.., C/O PORTFOLIOIP, P.O. BOX 52050, MINNEAPOLIS, MN, 55402, US

(21) Appl. No.: 12/062,321

(22) Filed: Apr. 3, 2008

Related U.S. Application Data
(60) Provisional application No. 60/909,736, filed on Apr. 3, 2007.

(51) Int. Cl. G06Q 40/00; G06Q 10/00; G06Q 50/00

(52) U.S. Cl. 705/7; 705/37; 705/36 R

(57) ABSTRACT

Methods and systems for facilitating exchange of rights associated with environmentally relevant items are provided. The methods and systems may include identifying a first environmentally relevant item, identifying a second environmentally relevant item and providing a software-based module for a market oversight facility by which at least one user may oversee at least one activity relevant to the first and second environmentally relevant items.

### CROSS-REFERENCE TO RELATED APPLICATIONS

This application claims the benefit of the following provisional application, which is hereby incorporated by reference in its entirety: U.S. Provisional Application No. 60/909,736, filed Apr. 3, 2007.

### BACKGROUND

1. Field

The invention relates to the field of environmentally relevant items, and more specifically to a platform for transacting environmentally relevant items, including creating, buying, selling, trading, tracking, clearing and/or retiring environmentally relevant items.

2. Description of the Related Art

With renewed focus being placed on environmental issues, environmentally relevant items are receiving increased attention. Various types of environmentally relevant items, such as renewable energy credits, energy efficiency certificates and carbon certificates, including carbon offset credits and emission allowances and emission reduction credits, have been created in various jurisdictions around the world. However, a need exists for systems and methods to systematically create, track, auction, buy, sell, trade, convert, retire, analyze and manage the various environmentally relevant items that exist around the world.

### SUMMARY

The methods and/or systems disclosed herein may include a platform (the “platform”) for transacting environmentally relevant items as described in more detail herein. Transactions may include creating, tracking, auctioning, buying, selling, trading, tracking, clearing, retiring and the like of one or more environmentally relevant items as described herein. In an embodiment, the platform may be a renewable energy tracking system, generation information systems or environmental registry or market depository. In an embodiment, the platform may be a greenhouse gas registry or an emissions and allowance tracking system. In an embodiment, the platform may create a technology infrastructure for a unified environmentally relevant item market for trading transferable, valuable environmentally relevant items. In an embodiment, the platform may comprise one platform for multiple environmentally relevant items. In an embodiment, the platform may comprise one platform for multiple jurisdictions, including localities, states, sub-regions, regions, countries and international jurisdictions

The platform may include various functionalities, features, facilities, engines and the like, including, but not limited to, a dashboard, reporting engine, exchange rate, analytic engine, jurisdictional complexity manager, cross-environmentally relevant item complexity manager, import/export manager, workflow manager, registry, market depository, compliance facility, trading engine, forensic reporting facility, market oversight facility, buying network, credit and clearing engine, timing manager, verification engine, rating engine, performance assessment facility, market data facility, billing engine, retirement facility, auction facility, allocation engine, search engine, protocol, content provision facility, environmentally relevant item serialization facility and the like.

The platform may be used by generators, offset providers, manufacturers, load serving entities, regulators, traders, brokers, clearinghouses, verifiers, corporations and the like. The platform may be used for industrial markets, voluntary markets, mandatory markets, cross-environmentally relevant item markets, cross-jurisdiction markets and the like. The platform may be deployed in a web-based manner and/or though a service oriented architecture. The platform may be hosted. The platform may interface with various data sources such as meters at production facilities, existing databases, market data providers, other platforms and the like. The data may be measured data, historical data, calculated data and the like.

The present invention provides methods and systems for facilitating exchange of rights associated with environmentally relevant items. The methods and systems may include identifying a first environmentally relevant item, identifying a second environmentally relevant item and providing a software-based module for a market oversight facility by which at least one user may oversee at least one activity relevant to the first and second environmentally relevant items.

In embodiments, the first and second environmentally relevant items may be of different types or of the same type. The first and second environmentally relevant items may relate to the same jurisdiction or different jurisdictions. In embodiments, the first and second environmentally relevant items may relate to different underlying environmental attributes or same underlying environmental attributes.

In embodiments, the user may be a regulator, a governmental user, a member of the public, a watch-dog group and the like. The user may use the market oversight facility to assess compliance with a law, rule and/or regulation. The user may use the market oversight facility to enforce compliance with at least one law, rule and regulation.

In embodiments, the module may consider an exchange rate between the environmentally relevant items. The module may consider a derivative environmentally relevant item based on the environmentally relevant items. The module may provide a user interface. The user interface may contain a dashboard that may display information relating to at least one environmentally relevant item. The module may be a subcomponent of a software platform for managing environmentally relevant items.

In embodiments, the user interface may facilitate applying an environmentally relevant item to offset an activity. The user interface may facilitate tracking the application of environmentally relevant items relating to an activity. The user interface may facilitate presentation of alternative options for obtaining environmentally relevant items in different jurisdictions. The user interface may be a dashboard allowing for tracking the impact of various environmentally relevant actions.

In embodiments, the environmentally relevant items may reside in a single depository. The depository may include environmentally relevant items of different types, different jurisdictions and the like. The environmentally relevant items may be a credit. In embodiments, the platform may be for a voluntary market, a mandatory market and the like. The platform may be web-based, hosted and the like. The environmentally relevant items may be entered in a single registry, a national registry and the like. The registry may be a web-based registry, a web-based carbon registry and the like.

In embodiments, the environmentally relevant items may be purchased for public relations purposes. In embodiments, the methods and systems may further include providing a software-based jurisdictional complexity manager, a cross-environmentally relevant item complexity manager, a software-based module for determining compliance, a software-based module for verifying attributes of environmentally relevant item, a software-based module for retiring environmentally relevant item, a software-based allocation engine module, a software-based module for reporting, a software-based module for forensic reporting, a software-based module for auditing, a software-based module for auctioning environmentally relevant item, a software-based module for trading environmentally relevant item and the like. Compliance may be determined with respect to law, rule or regulation.

In embodiments, the methods and systems may further include an analytic engine, a credit and clearing engine, a timing manager, a work flow manager, a buying network and the like. The analytic engine may perform analysis and calculations and may generate advice and recommendations. The environmentally relevant items may be purchased by a participant of a buying network. In embodiments, the methods and systems may further include providing a performance assessment facility, a market data facility, a billing engine, a content provision facility, an environmentally relevant item serialization facility and the like. In embodiments, the module may accesses data relating to the environmentally relevant items. The data may be compressed, meter-level data and the like. In embodiments, the environmentally relevant items may be specified by a protocol, a different protocol and the like. The environmentally relevant items may relate to carbon, energy efficiency, pollution reduction, renewable energy and the like.

In embodiments, the present invention provides methods and systems for facilitating exchange of rights associated with environmentally relevant items. The methods and systems may include identifying an environmentally relevant item relating to a first jurisdiction associated with an environmentally relevant action, identifying an environmentally relevant item relating to a second jurisdiction associated with an environmentally relevant action and providing a software-based module for a market oversight facility by which at least one user may oversee at least one activity relevant to the first and second environmentally relevant items.

In embodiments, the first and second environmentally relevant items may be of different types or of same type. The first and second environmentally relevant items may relate to the same jurisdiction or different jurisdictions. In embodiments, the first and second environmentally relevant items may relate to different underlying environmental attributes or the same underlying environmental attributes. In embodiments, the user may be a regulator, a governmental user, a member of the public, a watch-dog group and the like. The user may use the market oversight facility to assess compliance with a law, rule and/or regulation. The user may use the market oversight facility to enforce compliance with at least one law, rule and regulation.

In embodiments, the module may consider an exchange rate between the environmentally relevant items. The module may consider a derivative environmentally relevant item based on the environmentally relevant items. The module may provide a user interface. The user interface may contain a dashboard that may display information relating to at least one environmentally relevant item. The module may be a subcomponent of a software platform for managing environmentally relevant items.

In embodiments, the user interface may facilitate applying an environmentally relevant item to offset an activity. The user interface may facilitate tracking the application of environmentally relevant items relating to an activity. The user interface may facilitate presentation of alternative options for obtaining environmentally relevant items in different jurisdictions. The user interface may be a dashboard allowing for tracking the impact of various environmentally relevant actions.

In embodiments, the environmentally relevant items may reside in a single depository. The depository may include environmentally relevant items of different types, different jurisdictions and the like. The environmentally relevant items may be a credit. In embodiments, the platform may be for a voluntary market, a mandatory market and the like. The platform may be web-based, hosted and the like. The environmentally relevant items may be entered in a single registry, a national registry and the like. The registry may be a web-based registry, a web-based carbon registry and the like. In embodiments, the environmentally relevant items may be purchased for public relations purposes.

In embodiments, the methods and systems may further include providing a software-based jurisdictional complexity manager, a cross-environmentally relevant item complexity manager, a software-based module for determining compliance, a software-based module for verifying attributes of environmentally relevant item, a software-based module for retiring environmentally relevant item, a software-based allocation engine module, a software-based module for reporting, a software-based module for forensic reporting, a software-based module for auditing, a software-based module for auctioning environmentally relevant item, a software-based module for trading environmentally relevant item and the like. Compliance may be determined with respect to a law, rule and/or regulation.

In embodiments, the methods and systems may further include an analytic engine, a credit and clearing engine, a timing manager, a work flow manager, a buying network and the like. The analytic engine may perform analysis and calculations and may generate advice and recommendations. The environmentally relevant items may be purchased by a participant of a buying network. In embodiments, the methods and systems may further include providing a performance assessment facility, a market data facility, a billing engine, a content provision facility, an environmentally relevant item serialization facility and the like. In embodiments, the module may accesses data relating to the environmentally relevant items. The data may be compressed, meter-level data and the like. In embodiments, the environmentally relevant items may be specified by a protocol, a different protocol and the like. The environmentally relevant items may relate to carbon, energy efficiency, pollution reduction, renewable energy and the like.

In embodiments, the present invention provides methods and systems for facilitating exchange of rights associated with environmentally relevant items. The methods and systems may include identifying a first type of environmentally relevant item associated with an environmentally relevant action, identifying a second type of environmentally relevant item associated with an environmentally relevant action and providing a software-based module for a market oversight facility by which at least one user may oversee at least one activity relevant to the first and second environmentally relevant items.

In embodiments, the first and second environmentally relevant items may be of different types or of same type. The first and second environmentally relevant items may relate to the same jurisdiction or different jurisdictions. In embodiments, the first and second environmentally relevant items may relate to different underlying environmental attributes or same underlying environmental attributes. In embodiments, the user may be a regulator, a governmental user, a member of the public, a watch-dog group and the like. The user may use the market oversight facility to assess compliance with a law, rule and/or regulation. The user may use the market oversight facility to enforce compliance with at least one law, rule and regulation.

In embodiments, the module may consider an exchange rate between the environmentally relevant items. The module may consider a derivative environmentally relevant item based on the environmentally relevant items. The module may provide a user interface. The user interface may contain a dashboard that may display information relating to at least one environmentally relevant item. The module may be a subcomponent of a software platform for managing environmentally relevant items.

In embodiments, the user interface may facilitate applying an environmentally relevant item to offset an activity. The user interface may facilitate tracking the application of environmentally relevant items relating to an activity. The user interface may facilitate presentation of alternative options for obtaining environmentally relevant items in different jurisdictions. The user interface may be a dashboard allowing for tracking the impact of various environmentally relevant actions. In embodiments, the environmentally relevant items may reside in a single depository. The depository may include environmentally relevant items of different types, different jurisdictions and the like. The environmentally relevant items may be a credit. In embodiments, the platform may be for a voluntary market, a mandatory market and the like. The platform may be web-based, hosted and the like. The environmentally relevant items may be entered in a single registry, a national registry and the like. The registry may be a web-based registry, a web-based carbon registry and the like. In embodiments, the environmentally relevant items may be purchased for public relations purposes.

In embodiments, the methods and systems may further include providing a software-based jurisdictional complexity manager, a cross-environmentally relevant item complexity manager, a software-based module for determining compliance, a software-based module for verifying attributes of environmentally relevant item, a software-based module for retiring environmentally relevant item, a software-based allocation engine module, a software-based module for reporting, a software-based module for forensic reporting, a software-based module for auditing, a software-based module for auctioning environmentally relevant item, a software-based module for trading environmentally relevant item and the like. Compliance may be determined with respect to a law, rule and/or regulation.

In embodiments, the methods and systems may further include an analytic engine, a credit and clearing engine, a timing manager, a work flow manager, a buying network and the like. The analytic engine may perform analysis and calculations and may generate advice and recommendations. The environmentally relevant items may be purchased by a participant of a buying network.

In embodiments, the methods and systems may further include providing a performance assessment facility, a market data facility, a billing engine, a content provision facility, an environmentally relevant item serialization facility and the like. In embodiments, the module may accesses data relating to the environmentally relevant items. The data may be compressed, meter-level data and the like. In embodiments, the environmentally relevant items may be specified by a protocol, a different protocol and the like. The environmentally relevant items may relate to carbon, energy efficiency, pollution reduction, renewable energy and the like.

The present invention provides methods and systems for facilitating exchange of rights associated with environmentally relevant items. The methods and systems may include identifying a type of environmentally relevant item recognized by a first market associated with an environmentally relevant action, identifying a type of environmentally relevant item recognized by a second market associated with an environmentally relevant action and in a common platform, allowing at least one user to oversee at least one activity in the first market and the second market.

The present invention provides methods and systems for facilitating exchange of rights associated with environmentally relevant items. The methods and systems may include identifying a type of credit as an environmentally relevant item recognized by a first market associated with an environmentally relevant action, identifying a type of credit as an environmentally relevant item recognized by a second market associated with an environmentally relevant action, identifying a type of credit as an environmentally relevant item recognized by a third market associated with an environmentally relevant action, identifying a type of credit as an environmentally relevant item recognized by a fourth market associated with an environmentally relevant action and in a common platform, allowing at least one user to oversee at least one activity in all four markets, wherein the markets are selected from the group consisting of a renewable energy credit market, an energy efficiency credit market, a pollution reduction market and a carbon credit market.

In embodiments, the first and second environmentally relevant items may be of different types or of same type. The first and second environmentally relevant items may relate to the same jurisdiction or different jurisdictions. In embodiments, the first and second environmentally relevant items may relate to different underlying environmental attributes or same underlying environmental attributes. In embodiments, the user may be a regulator, a governmental user, a member of the public, a watch-dog group and the like. The user may use the market oversight facility to assess compliance with a law, rule and/or regulation. The user may use the market oversight facility to enforce compliance with at least one law, rule and regulation.

In embodiments, the module may consider an exchange rate between the environmentally relevant items. The module may consider a derivative environmentally relevant item based on the environmentally relevant items. The module may provide a user interface. The user interface may contain a dashboard that may display information relating to at least one environmentally relevant item. The module may be a subcomponent of a software platform for managing environmentally relevant items.

In embodiments, the user interface may facilitate applying an environmentally relevant item to offset an activity. The user interface may facilitate tracking the application of environmentally relevant items relating to an activity. The user interface may facilitate presentation of alternative options for obtaining environmentally relevant items in different jurisdictions. The user interface may be a dashboard allowing for tracking the impact of various environmentally relevant actions.

In embodiments, the environmentally relevant items may reside in a single depository. The depository may include environmentally relevant items of different types, different jurisdictions and the like. The environmentally relevant items may be a credit. In embodiments, the platform may be for a voluntary market, a mandatory market and the like. The platform may be web-based, hosted and the like. The environmentally relevant items may be entered in a single registry, a national registry and the like. The registry may be a web-based registry, a web-based carbon registry and the like. In embodiments, the environmentally relevant items may be purchased for public relations purposes.

In embodiments, the methods and systems may further include providing a software-based jurisdictional complexity manager, a cross-environmentally relevant item complexity manager, a software-based module for determining compliance, a software-based module for verifying attributes of environmentally relevant item, a software-based module for retiring environmentally relevant item, a software-based allocation engine module, a software-based module for reporting, a software-based module for forensic reporting, a software-based module for auditing, a software-based module for auctioning environmentally relevant item, a software-based module for trading environmentally relevant item and the like. Compliance may be determined with respect to a law, rule and/or regulation.

In embodiments, the methods and systems may further include an analytic engine, a credit and clearing engine, a timing manager, a work flow manager, a buying network and the like. The analytic engine may perform analysis and calculations and may generate advice and recommendations. The environmentally relevant items may be purchased by a participant of a buying network.

In embodiments, the methods and systems may further include providing a performance assessment facility, a market data facility, a billing engine, a content provision facility, an environmentally relevant item serialization facility and the like.

In embodiments, the module may accesses data relating to the environmentally relevant items. The data may be compressed, a meter-level data and the like. In embodiments, the environmentally relevant items may be specified by a protocol, a different protocol and the like. The environmentally relevant items may relate to carbon, energy efficiency, pollution reduction, renewable energy and the like. In embodiments, the present invention provides methods and systems for facilitating exchange of rights associated with environmentally relevant items. The methods and systems may include identifying a type of environmentally relevant item recognized by a first market associated with an environmentally relevant action, identifying a type of environmentally relevant item recognized by a second market associated with an environmentally relevant action and in a common platform, allowing at least one user to oversee at least one activity in the first market and the second market.

In embodiments, the first and second environmentally relevant items may be of different types or of same type. The first and second environmentally relevant items may relate to the same jurisdiction or different jurisdictions. In embodiments, the first and second environmentally relevant items may relate to different underlying environmental attributes or same underlying environmental attributes. In embodiments, the user may be a regulator, a governmental user, a member of the public, a watch-dog group and the like. The user may use the market oversight facility to assess compliance with law, rule and regulation. The user may use the market oversight facility to enforce compliance with at least one law, rule and regulation.

In embodiments, the present invention provides methods and systems for facilitating exchange of rights associated with environmentally relevant items. The methods and systems may include identifying a type of credit recognized by a first market associated with an environmentally relevant action, identifying a type of credit recognized by a second market associated with an environmentally relevant action and in a common platform, allowing users to oversee activity in the first market and the second market, wherein the first market is a carbon market and the second market is an energy efficiency market.

In embodiments, the first and second environmentally relevant items may be of different types or of same type. The first and second environmentally relevant items may relate to the same jurisdiction or different jurisdictions. In embodiments, the first and second environmentally relevant items may relate to different underlying environmental attributes or same underlying environmental attributes. In embodiments, the user may be a regulator, a governmental user, a member of the public, a watch-dog group and the like. The user may use the market oversight facility to assess compliance with law, rule and regulation. The user may use the market oversight facility to enforce compliance with at least one law, rule and regulation.

In embodiments, the present invention provides methods and systems for facilitating exchange of rights associated with environmentally relevant items. The methods and systems may include identifying a type of credit recognized by a first market associated with an environmentally relevant action, identifying a type of credit recognized by a second market associated with an environmentally relevant action and in a common platform, allowing users to oversee activity in the first market and the second market. The first market may be a carbon market and the second market may be a pollution reduction credit market.

In embodiments, the first and second environmentally relevant items may be of different types or of the same type. The first and second environmentally relevant items may relate to the same jurisdiction or different jurisdictions. In embodiments, the first and second environmentally relevant items may relate to different underlying environmental attributes or same underlying environmental attributes. In embodiments, the user may be a regulator, a governmental user, a member of the public, a watch-dog group and the like. The user may use the market oversight facility to assess compliance with law, rule and regulation. The user may use the market oversight facility to enforce compliance with at least one law, rule and regulation.

In embodiments, the present invention provides methods and systems for facilitating exchange of rights associated with environmentally relevant items. The methods and systems may include identifying a type of credit recognized by a first market associated with an environmentally relevant action, identifying a type of credit recognized by a second market associated with an environmentally relevant action and in a common platform, allowing users to oversee activity in the first market and the second market. The first market may be a carbon market and the second market may be a renewable energy market.

In embodiments, the first and second environmentally relevant items may be of different types or of the same type. The first and second environmentally relevant items may relate to the same jurisdiction or different jurisdictions. In embodiments, the first and second environmentally relevant items may relate to different underlying environmental attributes or same underlying environmental attributes. In embodiments, the user may be a regulator, a governmental user, a member of the public, a watch-dog group and the like. The user may use the market oversight facility to assess compliance with law, rule and regulation. The user may use the market oversight facility to enforce compliance with at least one law, rule and regulation.

In embodiments, the present invention provides methods and systems for facilitating exchange of rights associated with environmentally relevant items. The methods and systems may include identifying a type of credit recognized by a first market associated with an environmentally relevant action, identifying a type of credit recognized by a second market associated with an environmentally relevant action and in a common platform, allowing users to oversee activity in the first market and the second market. The first market may be a pollution reduction credit market and the second market may be an energy efficiency market.

In embodiments, the first and second environmentally relevant items may be of different types or of same type. The first and second environmentally relevant items may relate to the same jurisdiction or different jurisdictions. In embodiments, the first and second environmentally relevant items may relate to different underlying environmental attributes or same underlying environmental attributes. In embodiments, the user may be a regulator, a governmental user, a member of the public, a watch-dog group and the like. The user may use the market oversight facility to assess compliance with a law, rule and/or regulation. The user may use the market oversight facility to enforce compliance with at least one law, rule and regulation.

In embodiments, the present invention provides methods and systems for facilitating exchange of rights associated with environmentally relevant items. The methods and systems may include identifying a type of credit recognized by a first market associated with an environmentally relevant action, identifying a type of credit recognized by a second market associated with an environmentally relevant action and in a common platform, allowing users to oversee activity in the first market and the second market. The first market may be a renewable energy market and the second market may be an energy efficiency market.

In embodiments, the first and second environmentally relevant items may be of different types or of same type. The first and second environmentally relevant items may relate to the same jurisdiction or different jurisdictions. In embodiments, the first and second environmentally relevant items may relate to different underlying environmental attributes or the same underlying environmental attributes.

In embodiments, the user may be a regulator, a governmental user, a member of the public, a watch-dog group and the like. The user may use the market oversight facility to assess compliance with a law, rule and/or regulation. The user may use the market oversight facility to enforce compliance with at least one law, rule and regulation. In embodiments, the present invention provides methods and systems for facilitating exchange of rights associated with environmentally relevant items. The methods and systems may include identifying a type of credit recognized by a first market associated with an environmentally relevant action, identifying a type of credit recognized by a second market associated with an environmentally relevant action and in a common platform, allowing users to oversee activity in the first market and the second market. The first market may be a pollution reduction credit market and the second market may be a renewable energy market.

In embodiments, the first and second environmentally relevant items may be of different types or of same type. The first and second environmentally relevant items may relate to the same jurisdiction or different jurisdictions. In embodiments, the first and second environmentally relevant items may relate to different underlying environmental attributes or same underlying environmental attributes. In embodiments, the user may be a regulator, a governmental user, a member of the public, a watch-dog group and the like. The user may use the market oversight facility to assess compliance with law, rule and regulation. The user may use the market oversight facility to enforce compliance with at least one law, rule and regulation.

In embodiments, the present invention provides methods and systems for facilitating exchange of rights associated with environmentally relevant items. The methods and systems may include identifying a type of credit recognized by a first market associated with an environmentally relevant action, identifying a type of credit recognized by a second market associated with an environmentally relevant action, identifying a type of credit recognized by a third market associated with an environmentally relevant action and in a common platform, allowing users to oversee activity in the respective markets. The first market may be a renewable energy credit market, the second market may be an energy efficiency credit market and the third market may be a carbon credit market.

In embodiments, the first and second environmentally relevant items may be of different types or of same type. The first and second environmentally relevant items may relate to the same jurisdiction or different jurisdictions. In embodiments, the first and second environmentally relevant items may relate to different underlying environmental attributes or same underlying environmental attributes. In embodiments, the user may be a regulator, a governmental user, a member of the public, a watch-dog group and the like. The user may use the market oversight facility to assess compliance with a law, rule and/or regulation. The user may use the market oversight facility to enforce compliance with at least one law, rule and/or regulation.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a platform for environmentally relevant items;

FIG. 2 depicts an exemplary dashboard in accordance with an embodiment of the present invention;

FIG. 3 depicts an enterprise dashboard in accordance with an embodiment of the present invention;

FIG. 4 depicts a process for facilitating exchange of rights associated with environmentally relevant items involving a user interface in accordance with an embodiment of the present invention;

FIG. 5 depicts a process for providing a dashboard to a user for managing activities in accordance with another embodiment of the present invention;

FIG. 6 depicts a process for providing a dashboard to a user for managing activities in accordance with another embodiment of the present invention;

FIG. 7 depicts a process for providing a user interface for searching environmentally related actions in accordance with another embodiment of the present invention;

FIG. 8 depicts a market oversight facility for facilitating oversight of plurality of markets in accordance with an embodiment of the present invention;

FIG. 9 depicts a process for overseeing certain environmental activities in markets in a platform in accordance with another embodiment of the present invention;

FIG. 10 depicts a process for overseeing certain environmental activities in markets in a platform in accordance with another embodiment of the present invention;

FIG. 11 depicts a comparison of an environmentally relevant item with another environmentally relevant item or a financial instrument in accordance with an embodiment of the present invention;

FIG. 12 depicts a process for establishing a rate of exchange in accordance with another embodiment of the present invention;

FIG. 13 depicts a process for establishing a rate of exchange in accordance with another embodiment of the present invention;

FIG. 14 depicts a process for establishing a rate of exchange between jurisdictions in accordance with another embodiment of the present invention;

FIG. 15 depicts a process for providing an environmental derivative instrument in accordance with another embodiment of the present invention;

FIG. 16 depicts a jurisdictional complexity manager in accordance with an embodiment of the present invention;

FIG. 17 depicts a process for providing a cross-environmentally relevant item complexity manager module in accordance with another embodiment of the present invention;

FIG. 18 depicts a cross-environmentally relevant item complexity manager in accordance with an embodiment of the present invention;

FIG. 19 depicts a process for providing a cross-environmentally relevant item complexity manager module in accordance with another embodiment of the present invention;

FIG. 20 depicts a process for providing a cross-environmentally relevant item complexity manager module for managing relevant actions in accordance with yet another embodiment of the present invention;

FIG. 21 depicts an import/export manager in accordance with an embodiment of the present invention;

FIG. 22 depicts a process for providing unified depository for credits in accordance with another embodiment of the present invention;

FIG. 23a depicts forward transactions between a platform and environmentally relevant items in accordance with an embodiment of the present invention;

FIG. 23b depicts a process for purchase and/or sale of environmentally relevant items in accordance with an embodiment of the present invention;

FIG. 24 depicts a process for facilitating placement of standing orders in accordance with another embodiment of the present invention;

FIG. 25 depicts a rating engine for rating of environmentally relevant items in accordance with an embodiment of the present invention;

FIG. 26 depicts a process for providing a user interface to a user in accordance with another embodiment of the present invention;

FIG. 27 depicts a process for facilitating retirement of environmentally relevant items in accordance with an embodiment of the present invention;

FIG. 28 depicts an allocation process performed by an allocation engine in accordance with an embodiment of the present invention;

FIG. 29 depicts a process for providing an allocation engine in accordance with another embodiment of the present invention;

FIG. 30 depicts a process for providing an allocation engine in accordance with another embodiment of the present invention;

FIG. 31 depicts a search engine depicting various views in a platform in accordance with an embodiment of the present invention;

FIG. 32 depicts a user interface for viewing a portfolio in accordance with an embodiment of the present invention;

FIG. 33 depicts a user interface for viewing a portfolio in accordance with another embodiment of the present invention;

FIG. 34 depicts a user interface for viewing transactions in accordance with an embodiment of the present invention;

FIG. 35 depicts a user interface for viewing transactions in accordance with another embodiment of the present invention; and

FIG. 36 depicts a user interface for viewing transfers in accordance with another embodiment of the present invention.

### DETAILED DESCRIPTION

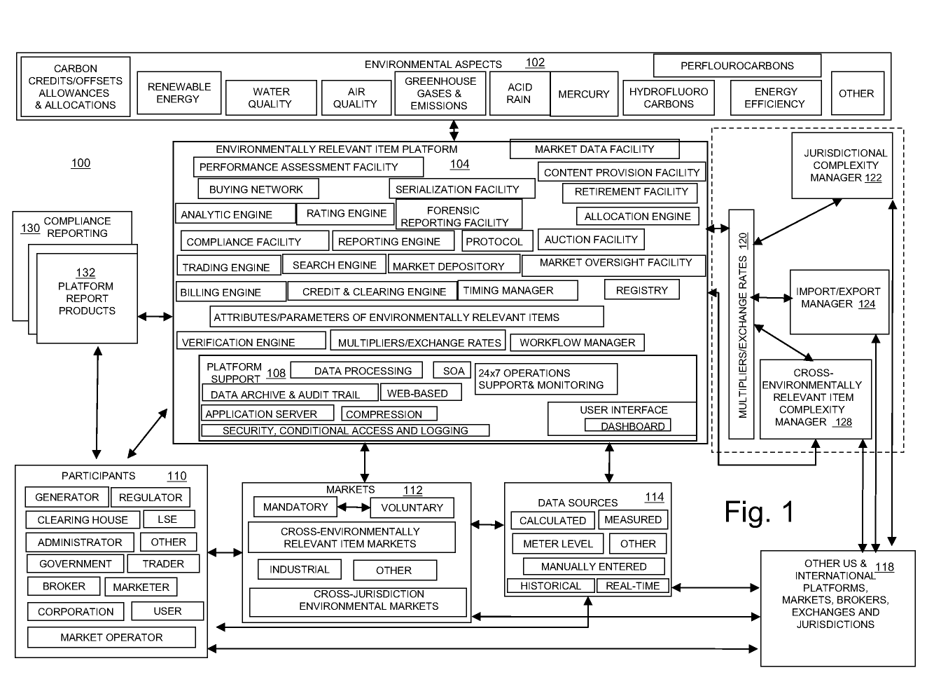

FIG. 1 depicts an environmentally relevant item platform 104 for environmentally relevant items. The platform 104 may support or be associated with one or more environmentally relevant items. An environmentally relevant item, as used herein, should be understood, except where context calls for a more specific meaning, to encompass any of a wide range of items one or more attributes of which has relevance to the environment, such as environmentally relevant securities, financial instruments, contracts, commodities, credits, debits, debts, obligations, goods, services, actions, or the like, including, without limitation of the foregoing, items relevant to energy production or consumption, renewable energy consumption or production, carbon consumption or reduction or production, greenhouse gas emissions or emissions permits, emission allowances, pollution production, disposal or modification, water usage or preservation, emission reduction, chlorofluorocarbon production, usage, or destruction, and many others.

Referring to FIG. 1, the environmentally relevant items platform 104 may include various functionalities, features, facilities, engines and the like, including, but not limited to, a dashboard, reporting engine, forensic reporting facility, exchange rate, analytic engine, jurisdictional complexity manager 122, cross-environmentally relevant item complexity manager 128, import/export manager 124, workflow manager, registry, market depository, compliance facility, trading engine, market oversight facility, buying network, credit and clearing engine, timing manager, verification engine, rating engine, performance assessment facility, market data facility, billing engine, retirement facility, auction facility, allocation engine, search engine, protocol, content provision facility, environmentally relevant item 202 serialization facility, and the like, any one of which may be embodied in a module, such as a software module. As shown in FIG. 1 the platform 104 may interface or be associated with various environmental aspects, reports such as compliance reporting 130 and platform report products 132, and some other type of reporting, participants 110, data sources 114, other platforms 104, markets 112, brokers, exchanges, and the like. The jurisdictional complexity manager 122, cross-environmentally relevant item complexity manager 128, import/export manager 124 and multipliers and exchange rates 120 may be components of the platform 104 or may be separate from the platform 104. The jurisdictional complexity manager 122, cross-environmentally relevant item complexity manager 128, import/export manager 124 and multipliers and exchange rates 120 may be associated with intra-platform 104 transactions and activities. The jurisdictional complexity manager 122, cross-environmentally relevant item complexity manager 128, import/export manager 124 and multipliers and exchange rates 120 may be associated with inter-platform transactions and activities, such as transactions with other platforms 118, markets 112, brokers, exchanges, and the like.

An environmentally relevant item 202 may be a renewable energy certificate or credit (REC), also known as a green tag or tradable renewable certificate (TRC). Typically one green tag corresponds to 1000 kWh of electricity generated from renewable energy sources. Instead of functioning as a tax on pollution creating electricity generators, green tags function as a non-governmental subsidy on pollution-free electricity generators. An environmentally relevant item 202 may be or represent the avoided emissions related to a REC. An environmentally relevant item 202 may be an energy efficiency certificate (EEC), also known as a white tag. Typically an EEC is a document certifying that a certain reduction of energy consumption has been attained. EECs are often combined with an obligation to achieve a certain target of energy savings. An environmentally relevant item 202 may be or represent the avoided emissions related to an EEC. An environmentally relevant item 202 may be a carbon certificate (CC). Typically a CC provides the owner with the right to emit one ton of carbon dioxide.

An environmentally relevant item 202 may be a credit. The term credit as used herein and in the figures is understood to be any one of a number of environmentally relevant items 202. An environmentally relevant item 202 may also be a carbon emission reduction credit, a carbon offset, such as a verified emissions reduction (VER), carbon emission reduction (CER), an emission reduction unit (ERU) or a voluntary carbon unit (VCU), an emissions allowance, an energy conservation certificate, a carbon avoidance certificate, a residential emission reduction credit, a tradable residential emission reduction credit, a residential renewable energy certificate, a tradable residential renewable energy certificate, a carbon credit or offset or emission allocation, a renewables obligation certificate, a water credit, a water permit, a mercury allowance or permit, or a credit relating to other markets 112, and the like. An environmentally relevant item 202 may be any type of credit, certificate or allocation relating to one or more of any form of pollution, pollution reduction, environmental measure or benefit and the like. The environmentally relevant item may be any substance that the consumption or production of which is environmentally sensitive, and for which cap-and-trade or other market-based mechanisms may be used to curtail consumption or production. The systems and methods described herein may support such processes. An environmentally relevant item 202 may be a digital certificate. An environmentally relevant item 202 may be used to satisfy or may represent an obligation. An environmentally relevant item 202 may be a derivative. An environmentally relevant item 202 may be a meta-level environmentally relevant item 202. A meta-level environmentally relevant item 202 may be a combination of environmentally relevant items 202. A meta-level environmentally relevant item 202 may be a combination of one or more environmentally relevant items 202 with one or more financial instruments, including, without limitation, securities and commodities. A meta-level environmentally relevant item 202 may be a derivative measure, such as carbon avoided by use of a REC. A meta-level environmentally relevant item 202 may be an offset.

An environmentally relevant item 202 may be characterized by various attributes and/or parameters. The attributes may be managed as tags. The platform 104 may receive, generate, process, store and provide data relating to one or more attributes of one or more environmentally relevant items 202. One attribute of an environmentally relevant item 202 may be a serial number which may be unique. Another attribute of an environmentally relevant item 202 may be the applicable laws, regulatory regimes and the like. An attribute of an environmentally relevant item 202 may be the restrictions on transfer placed upon it. An attribute of an environmentally relevant item 202 may be a list of environmentally relevant items 202 for which it may be traded. This list may be accompanied by the relevant exchange rates which may change with market conditions. An attribute of an environmentally relevant item 202 may relate to geographic or jurisdictional information. In an embodiment, the geographic or jurisdictional information may be the site, locality, state, sub-region, region and/or country of generation, consumption and/or retirement of an environmentally relevant item 202. An attribute of an environmentally relevant item 202 may relate to the quality of the environmentally relevant item 202, such as the quality assessed by the rating engine.

An attribute of an environmentally relevant item 202 may relate to date and time information concerning the environmentally relevant item 202. The date and time information may be the date/time of generation or a category of time such as on-peak or off-peak. The date and time information may be the date/time of sale, date/time of consumption, date/time of time to retirement, date/time of expiration, time to settlement, time to expiration, dates of applicable regulatory periods and the like. An attribute of an environmentally relevant item 202 may relate to information concerning the source and ownership history of the environmentally relevant item 202. Information concerning the source and ownership history of an environmentally relevant item 202 may include the party who generated the environmentally relevant item 202, the party who owns the environmentally relevant item 202 and the like. Information concerning the source of an environmentally relevant item 202 may include by what process the environmentally relevant item 202, representing an environmental benefit, was created. In an embodiment, source information may include the type of renewable energy power generation used, such as solar, wind, biomass, geothermal and the like). In another embodiment, source information may include the type of carbon offset created, such as methane reduction via a process improvement, carbon sequestration via reforestation and the like. In another embodiment, source information may include information regarding the allocation or auction mechanism and jurisdictional information by which an emission allowance or allocation was created by a jurisdiction or government agency.

An attribute of an environmentally relevant item 202 may relate to information concerning the transaction history of an environmentally relevant item 202. Information concerning the transaction history of an environmentally relevant item 202 may include an ownership trail for the environmentally relevant item 202, a list of all the previous transactions involving the environmentally relevant item 202, historical pricing and the like. An attribute of an environmentally relevant item 202 may relate to exchange rates associated with the environmentally relevant item 202 or with one or more attributes of the environmentally relevant item 202. The exchange rate may relate to location and jurisdiction information, population density, on-peak or off-peak timing and/or any of the other factors discussed herein.

An attribute of an environmentally relevant item 202 may be the value or price of the environmentally relevant item 202. An attribute of an environmentally relevant item 202 may relate to ratings information or parameters relating to trust associated with the environmentally relevant item 202. This information may relate to whether the environmentally relevant item 202 is from a trusted source, the likelihood of green washing or double counting and the like. An attribute of an environmentally relevant item 202 may relate to metadata surrounding verification of the environmentally relevant item 202. This metadata may include information concerning who performed the verification, how the verification was performed, the protocol was used for verification and the like. This metadata may also include copies of any related documentation, photographs, attestations and the like. The trust related attributes may allow for the creation of a trusted environmentally relevant item 202.

Environmentally relevant items 202 may be transacted. Transactions may include auctioning, buying, selling, trading, creating and retiring environmentally relevant items 202. Transactions may include moving an environmentally relevant item 202 to and/or between sub-accounts within an account or to and/or between subsets of a platform. A transaction may be brokered or direct. A transaction may be conducted on an exchange or using other means of credit management and clearing.

In an embodiment a transaction may be a brokered transaction for RECs. The RECs may be produced by a generator, consumed by a LSE and traded between generation and use. The RECs may be bought and sold by a broker. The generator may forward sell the RECs. Both parties may have standing orders to buy and sell RECs at certain prices. The transaction may also be a forward transfer involving reconciliation. The transaction may also involve the import and/or export of RECs or an exchange of RECs. The transaction may be cross-jurisdictional, where the jurisdiction may be a locality, state, sub-region, region or nation with distinct regulatory and compliance authorities.

In another embodiment, a transaction may be a brokered transaction for carbon offsets (credits) or emissions allocations. In the case of offsets or credits, they may be produced by the project owners. The transaction may involve forward sales of future credits. The transaction may involve imports and exports of credits. The transaction may involve emissions allocations purchased in an auction process. The transaction may involve standing orders to buy and sell. The transaction may be a forward transfer involving reconciliation. The transaction may be a direct exchange. The transaction may be cross-jurisdictional, where the jurisdiction may be a locality, state, sub-region, region or nation with distinct regulatory and compliance authorities.

In yet another embodiment, the transaction may be a brokered transaction for EECs, which may be produced by a corporation. The transaction may involve forward sales; for example, a generator may forward sell EECs. The transaction may involve imports and exports of EECs. The transaction may involve standing orders to buy and sell EECs. The transaction may be a forward transfers involving reconciliation. The transaction may be a direct exchange. The transaction may be cross-jurisdictional, where the jurisdiction may be a locality, state, sub-region, region or nation with distinct regulatory and compliance authorities.

In an embodiment, a transaction may involve a green tag (also known as a REC). An environmentally friendly energy producer, such as a wind farm, may produce 1000 kWh of electricity and be credited with one green tag. The electricity produced may then be fed into the power grid and the energy producer may then sell the green tag on the market using the platform. A retailer may purchase the green tag, along with additional green tags, so that it can claim for marketing purposes that its energy use is carbon neutral and does not contribute to global warming.

In another embodiment, a transaction may involve a white tag (also known as an EEC). A producer, supplier or distributor of natural gas, or another energy commodity, may undertake efficiency measures, such as by increasing efficiency by a certain percentage of its annual energy delivery amount. In exchange, the producer, supplier or distributor may earn a white certificate which may be used for its own compliance needs or which may be sold or traded using the platform.

In yet another embodiment, a transaction may involve a carbon credit. A factory may be permitted to emit 50,000 tons of greenhouse gases in a year. The factory may only emit 45,000 tons annually and through various pollution abatement measures, such as changes in the manufacturing process, the factory may have further reduced its annual emissions to 40,000 tons of greenhouse gases. As a result, the factory may have an excess of 10,000 carbon credits or emission allocations which it can sell, trade, save and/or retire. The factory may decide to sell 5,000 carbon credits, emissions allowances or allocations on the market using the platform. The factory may also decide to retire 2,500 carbon credits using the platform 104 for public relations and marketing reasons. The factory may decide to save 2,500 carbon credits in case its emission quota is reduced by more than expected for the next year. The factory decides to do this even though a certain amount of the 2,500 carbon credits it saves may expire or be proportionately reduced.

An environmentally relevant item 202 may relate to one or more of many different environmental aspects 102. Environmental aspects 102 may include carbon or carbon equivalent emissions, carbon emissions avoidance, reduction or offset, carbon emissions allowances, renewable energy, which may be characterized by a locality component, a time of day component or other metadata, energy efficiency, water quality, phosphorous, selenium, wind, air quality, contaminants, pollutants, deforestation, including both old growth and replanting, mercury, acid rain, hydrofluorocarbons, perflourocarbons, solar energy, hydrogen, deep-water cooling, natural gas, coal or petroleum equivalence, greenhouse gases and emissions, including carbon dioxide, methane, nitrous oxide, CFC-12, HCFC-12, tetraflouromethane, sulfur hexafluoride and the like, sulfur dioxide, other volatile organic compounds and the like.

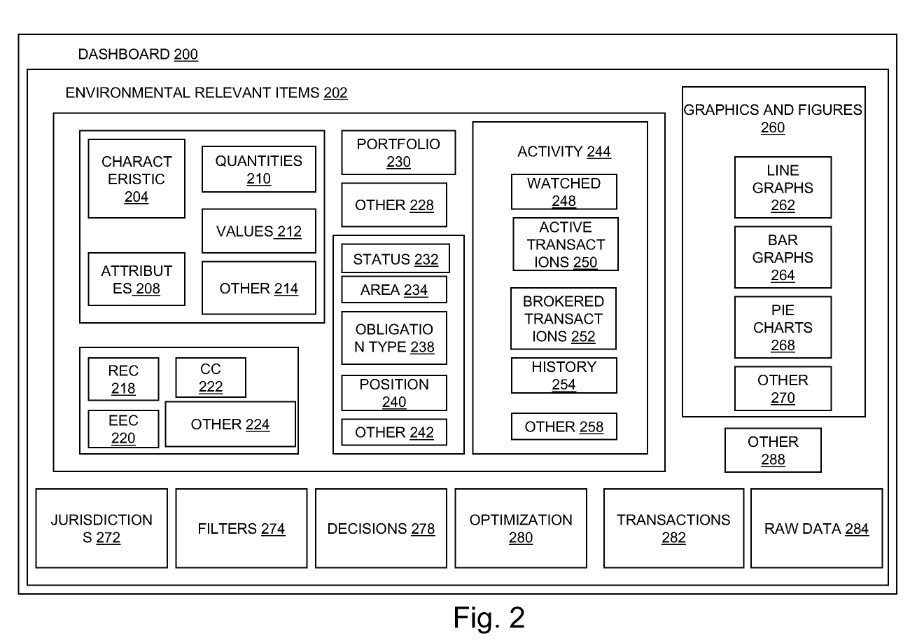

FIG. 2 depicts an exemplary dashboard 200 in accordance with an embodiment of the present invention. In embodiments, the platform 104 may include the dashboard 200. The dashboard 200 may combine the display of characteristics 204, attributes 208, quantities 210, values 212, other items 214, and the like of one or more environmentally relevant items 202 in a single user interface. In embodiments, there may be plurality of environmentally relevant items 202. In embodiments, the dashboard 200 may be a multi-environmentally relevant item 202, multi-jurisdiction environmental dashboard. In an embodiment, the dashboard 200 may combine the display of RECs 218, EECs 220, and CCs 222, or any other credits 224 or environmentally relevant items 202 (including credits, offsets, allowances, allocations and the like) or other 228 environmentally relevant items 202, displaying them as a portfolio 230 of managed environmentally relevant items 202. The platform 104 may show the status 232 of a particular environmentally relevant item 202 or a group of environmentally relevant items 202 by area 234, obligation type 238, position 240, other 242 (such as long or short), and the like. The platform 104 may show the activity 244 of a particular environmentally relevant item 202 or a group of environmentally relevant items 202 such as by listing environmentally relevant items 202 being watched 248, listing active transactions 250, inactive transactions and/or brokered transactions 252, providing past history 254, other activity or information 258, and the like. The dashboard 200 may show views based on different environmentally relevant items 202. The dashboard 200 may allow for the application of filters 274 and multiple filters at the same time. The dashboard 200 may present various views of the overall portfolio 230 of environmentally relevant items 202 or specific aspects of the portfolio 230 of other environmentally relevant items 202. The dashboard 200 may enable a user to make decisions 278 regarding transactions 282 involving environmentally relevant items 202. The dashboard 200 may allow a user to determine how to optimize 280 and/or maximize the value of a portfolio of environmentally relevant items 202. The dashboard 200 may present raw data 284. The dashboard 200 may present graphics or figures 260. The dashboard 200 may present line graphs 262, bar graphs 264, pie charts 268, other graphics or figures 270, and the like. The dashboard may present information or views relating to or associated with one or more jurisdictions 272. The dashboard may present other information 288.

The dashboard may present different views of a particular environmentally relevant item 202 or a group of environmentally relevant items 202, such as an asset-based view, attribute-based view, including a jurisdictional view, obligation-based view, credit-based view, transaction-based view, import/export-based view, gap analysis view, time-based view and the like. One or more of the various views may be presented simultaneously. The dashboard 200 or various aspects of the dashboard 200 may be varied by specific user of the dashboard 200. The dashboard 200 may be customized to specific user's preferences. The dashboard 200 or various aspects of the dashboard 200 may be varied by the category of the user of the dashboard 200. As a result the following different dashboards may exist: an enterprise dashboard, governmental entity dashboard, market maker dashboard, broker dashboard, host dashboard, administrator dashboard, generator dashboard, LSE dashboard, regulator dashboard, corporate level cross-jurisdictional dashboard, geographic dashboard, and the like. In an embodiment, the dashboard 200 may be customized to a specific corporation's preferences, including corporate re-branding for internal uses by a corporation and its clients.

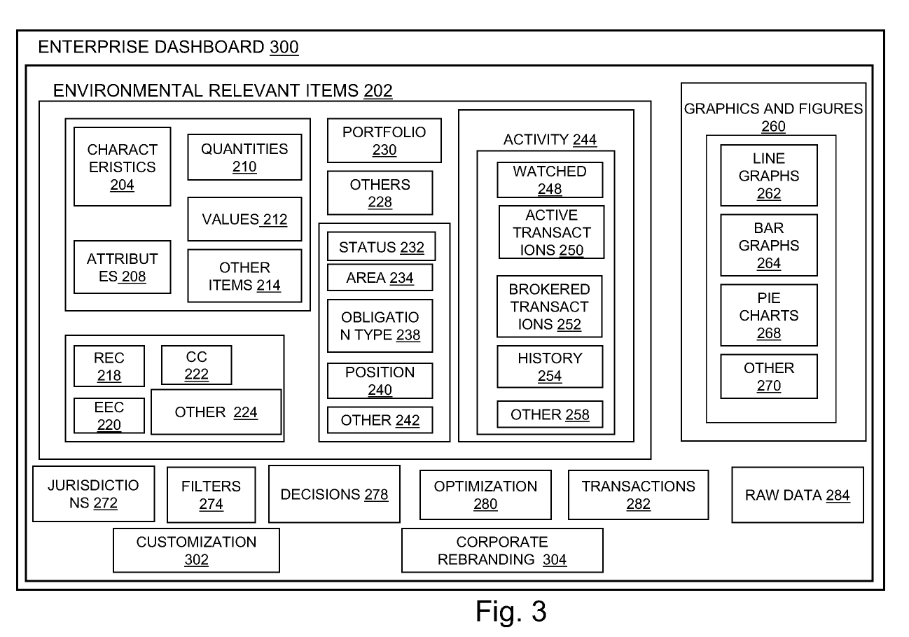

FIG. 3 depicts an enterprise dashboard 300 in accordance with an embodiment of the present invention. In embodiments, enterprise dashboard 300 may be included as part of a larger platform. The enterprise dashboard 300 may combine the display of characteristics 204, attributes 208, quantities 210, values 212, other items 214, and the like of environmentally relevant items 202 in a single user interface. The enterprise dashboard 300 may be a multi-environmentally relevant item 202, multi-jurisdiction environmental dashboard. In an embodiment, the dashboard 300 may combine the display of RECs 218, EECs 220, and CCs 222, or any other credits 224 (including credits, offsets, allowances, allocations and the like) or other 328 environmentally relevant items 202, displaying them as a portfolio 230 of managed environmentally relevant items 202. The platform 104 may show the status 232 of a particular environmentally relevant item 202 or a group of environmentally relevant items 202 by area 234, obligation type 238, position 240, other attribute 242 (such as long or short), and the like. The platform 104 may show the activity 244 of a particular environmentally relevant item 202 or a group of environmentally relevant items 202 such as by listing environmentally relevant items 202 being watched 248, listing active transactions 350, listing inactive transactions, listing past transactions and/or brokered transactions 252, providing past history 354, summaries of other activity 358, and the like. The enterprise dashboard 300 may show views based on different environmentally relevant items 202. The enterprise dashboard 300 may allow for the application of filters 274 and multiple filters at the same time. The enterprise dashboard 300 may present various views of the overall portfolio 230 of environmentally relevant items 202 or specific aspects of the portfolio 230 of environmentally relevant items 202. The enterprise dashboard 300 may enable a user to make decisions 278 regarding transactions 282 involving environmentally relevant items 202. The enterprise dashboard 300 may allow a user to determine how to optimize 280 and/or maximize the value of a portfolio of environmentally relevant items 202. The enterprise dashboard 300 may present raw data 284. In embodiments, the enterprise dashboard 300 may be customized 302 to a specific user's preferences. In further embodiments, the enterprise dashboard 300 may enable corporate re-branding 304 for a corporation and/or its clients. In an embodiment, the enterprise dashboard 300 may be customized to a specific corporation's preferences, including corporate re-branding 304 for internal uses by a corporation and its clients. The enterprise dashboard 300 may present graphics or figures 260. In embodiments, the enterprise dashboard 300 may present line graphs 262, bar graphs 264, pie charts 268, other graphics or figures 270, and the like.

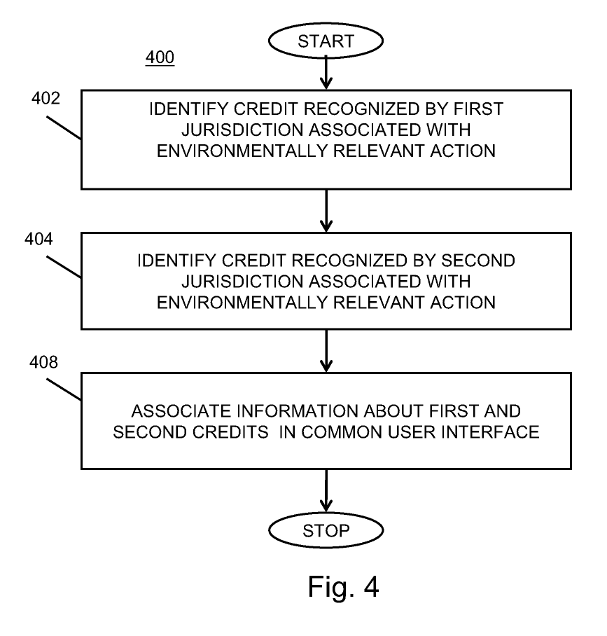

An aspect of the present invention relates to a method for facilitating exchange of rights associated with environmentally relevant items 202. In an example, environmentally relevant items 202 may be in the form of equities, options, warrants, futures, listed managed investments, interest rate securities, and the like. Referring to FIG. 4, a process 400 may be illustrated. The process 400 may begin at step 402, where a credit recognized by a first jurisdiction may be identified. This credit may be identified as a first type of credit. In an example, the first type of credit may be a carbon credit. In embodiments, the jurisdiction may be a locality, state, sub-region, region or nation or a jurisdiction with at least one particular regulatory and compliance authority. Further, the process 400 may identify a second type of credit at step 404. The second type of credit may be recognized by a second jurisdiction. In an aspect of the invention, the second type of credit may be an emissions allowance provided to an organization for controlling pollution. Further, the emission allowance may be approved by a jurisdiction such as a pollution control department of a country, European Union Emission Trading Scheme, or some other type of jurisdiction. In embodiments, the first and the second types of credits may be associated with an environmentally relevant action. The environmentally relevant action may be buying, selling, exchanging, and the like. For example, the first type of environmentally relevant action may be buying of carbon credits in the market, producing a good in a factory or operating an airplane. The process 400 may proceed finally to step 408. At step 408, information regarding the first and second types of credits may be associated with a common user interface. In embodiments, the common user interface may be a graphical user interface, a voice based interface, a web-based interface, a tactile or touch-based, and some other type of user interface.

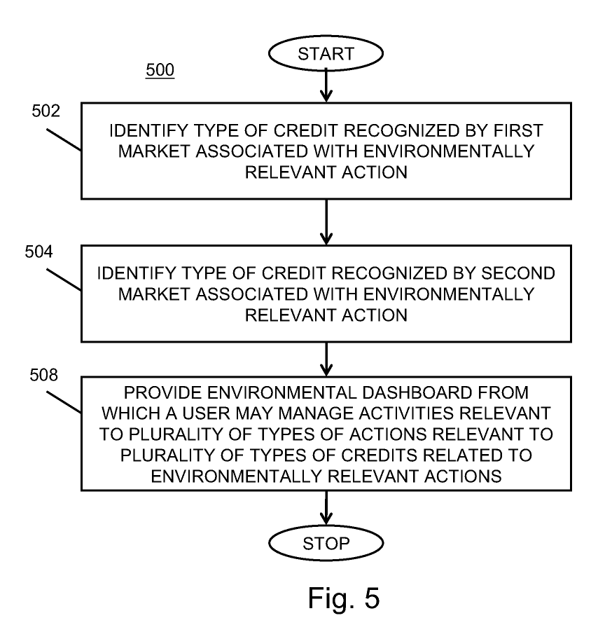

Referring to FIG. 5, a process 500 is illustrated for facilitating exchange of rights associated with environmentally relevant items 202. The process 500 may begin at step 502 where a type of credit recognized by a first market may be identified. In embodiments, the type of credit may be a carbon emission reduction credit, and the like. In embodiments, the type of credit may be associated with an environmentally relevant action. In embodiments, the first market may include industrial markets, voluntary markets, mandatory markets, and the like. In embodiments, the environmentally relevant action may be buying, selling, exchanging, and the like. At step 504, a type of credit recognized by a second market may be identified. In embodiments, the type of credit may be associated with an environmentally relevant action, where the second market may include industrial markets, voluntary markets, mandatory markets, and the like. Finally at step 508, the environmental dashboard 200 may be provided. In embodiments, the environmental dashboard 200 may be used by a user to manage activities relevant to a plurality of types of credits. In embodiments, the dashboard 200 may combine the display of characteristics 204, attributes 208, quantities 210, values 212, and the likes of environmentally relevant items 202 in a single user interface.

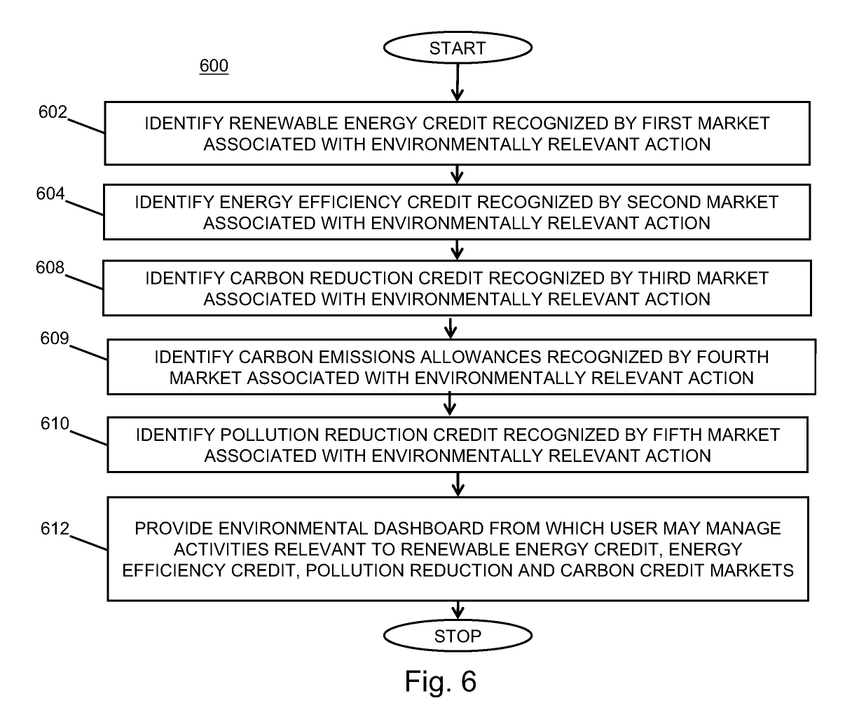

In embodiments, a method 600 for facilitating exchange of rights associated with environmentally relevant items 202 may be provided. In an example, environmentally relevant items 202 may be in the form of carbon credits, emission allowance, and the like. Referring to FIG. 6, at step 602, the REC 218 recognized by a first market and associated with an environmentally relevant action may be identified. The first market may be a renewable energy credit market, industrial market, voluntary market, regulatory market, and the like. Further, the environmentally relevant action may be buying, selling, exchanging, trading, and the like. Following this, at step 604, the EEC 220 recognized by a second market associated with an environmentally relevant action may be identified. At step 608, a carbon reduction credit recognized by a third market associated with an environmentally relevant action may be identified. For example, the carbon reduction credit, recognized by the REC 218 market and associated with an environmental security, say emission allowance, may be identified. Further, the carbon reduction credit may be associated with buying of carbon credits 222 in the market. At step 608, a carbon reduction credit recognized by a third market associated with an environmentally relevant action may be identified. At step 609, a carbon emission allowance recognized by a fourth market associated with an environmentally relevant action may be identified. In a similar manner, a pollution reduction credit recognized by a fifth market associated with an environmentally relevant action may be identified at step 610. Further, the environmental dashboard 200 may be provided to a user at step 612. The environmental dashboard 200 may allow the user to manage activities relevant to the REC 218, the EEC 220, the pollution reduction, and the carbon credit 222 markets 112. In embodiments, the environmental dashboard 200 may combine the display of RECs, EECs, and CCs (including credits, offsets, allowances, allocations and the like) or other environmentally relevant items 202, displaying them as a portfolio of managed environmentally relevant items 202.

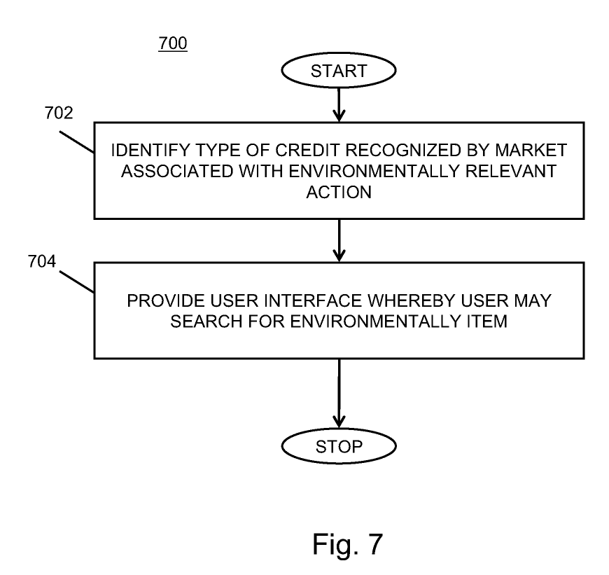

In embodiments, a process 700 for facilitating exchange of rights associated with environmentally relevant items 202 may be provided. Referring to FIG. 7, at step 702, a type of credit recognized by a market associated with the environmentally relevant action may be identified. The market may be a renewable energy credit market industrial market, voluntary market, regulatory market and the like. For example, the carbon credit 222, recognized by a renewable energy credit market industrial market and associated with an environmental security, say emission allowance, may be identified. The environmentally relevant action may also be buying, selling, exchanging, and the like. Following this, at step 704, a user interface may be provided which may enable a user to search for environmentally relevant actions with a credit-based view. The user interface may be provided for the search engine of the platform 104. In embodiments, the user interface in the search engine may allow for creation of a credit-based view of environmentally relevant items 202. Upon creation of the credit-based view, the user may search the environmentally relevant action by using the user interface.

The platform 104 may include a reporting engine. The reporting engine may generate various reports and report products. The reporting engine may generate compliance reports. The reporting engine may generate reports based on attributes or combinations of attributes or other characteristics of environmentally relevant items 202. The reporting engine may generate reports by trader, producer, consumer, jurisdiction, such as local, state, sub-regional, regional, national and international, regulatory agent, regulatory regime, reporting period and the like. The reporting engine may generate a trading report, a transaction report, a retirement report, a quality report, a market condition report and the like. The reporting engine may track the history of an environmentally relevant item 202 and/or group of environmentally relevant items 202. The reporting engine may monitor for green-washing and/or double-counting. The reporting engine may generate a report of the history. The reporting engine may include a facility to perform immediate ad hoc queries and generate custom reports. The reporting engine may generate reports for purposes of auditing, audit trails, forensic reporting, regulatory compliance, financial compliance and market oversight. In embodiments, the reporting engine, possibly in association with the market oversight facility, may generate reports that enable oversight for the general public and industry watchdog groups. The reporting engine may provide a report with a breakdown of source of the actions resulting in the environmentally relevant item 202. The reporting engine may report on the historical demand, supply, price and the like of an environmentally relevant item 202. The reporting engine may enable regulators to assess the overall performance of the market and the impact on the economy.

The platform 104 may contain a forensic reporting facility. The forensic reporting facility may query the platform 104 for historical information. The forensic reporting facility may generate historical reports. In an embodiment, the forensic reporting facility may uncover or understand areas of potential fraud or market manipulation by market participants 110. In embodiments, the forensic reporting facility may provide information that is non-falsifiable and such information may be recoverable under court or regulatory order. In an embodiment, the forensic reporting facility may allow for the creation or re-creation of records containing the environmentally relevant items 202 transacted in one or more accounts in during a certain period. In an embodiment, the forensic reporting facility may re-create the key strokes of a particular participant. In an embodiment, the forensic reporting facility may create a log of transactions and actions taken by an individual or organization or a group of individuals or organizations. In an embodiment, the forensic reporting facility may be directly accessible by a regulator. In an embodiment, the forensic reporting facility may permit assessment of compliance with laws, rules and/or regulations.

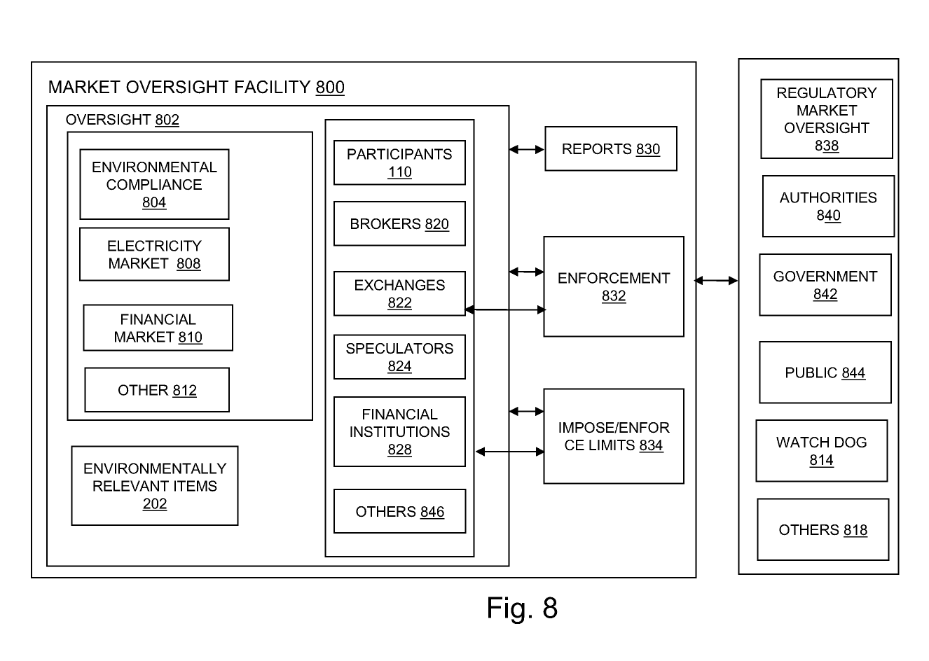

FIG. 8 depicts a market oversight facility 800 for facilitating oversight of a plurality of markets 112 in accordance with an embodiment of the present invention. In embodiments, the platform 104 may include a market oversight facility 800. The market oversight facility 800 may facilitate oversight 802 of one or more markets 112 where environmentally relevant items 202 may be transacted. The market oversight facility 800 may generate reports 830 that enable regulatory market oversight 838 and oversight of various markets 112 and groups including the electricity market 808, financial market 810 and others 812 by multiple oversight authorities 840, including, without limitation, environmental compliance oversight regulators 804, electricity market oversight regulators, financial market oversight regulators, authorities 840, government 842, the public 844, watch dog groups 814 and/or others 818. In embodiments, environmental compliance oversight 804 may include oversight of emissions reduction. In embodiments, electricity market oversight 808 may include oversight of reduction of electricity usage. In embodiments, financial market oversight 810 may include oversight of securities, commodities, brokers 820 and exchanges 822. In an embodiment, the market oversight facility 800 may enable the platform 104 to impose/enforce limits 834 on the quantity of trading or position limits for certain types of market participants 110, such as financial institutions 828, brokers 820, exchanges 822, speculators 824 and/or others 846, or for certain types of environmentally relevant items 202. In addition, the imposed/enforced limits 834 may be associated with oversight 802. In embodiments, an enforcement facility 832 may be associated with enforcement activities of the market oversight facility 800. In embodiments, enforcement 832 may be associated with exchanges 822. In embodiments, the market oversight facility 800 may support multiple types of market oversight from a single platform 104. In an embodiment, the market oversight facility 800 may impose and/or enforce trading limits 834 and/or position limits for certain environmentally relevant items 202 for certain participants 110.

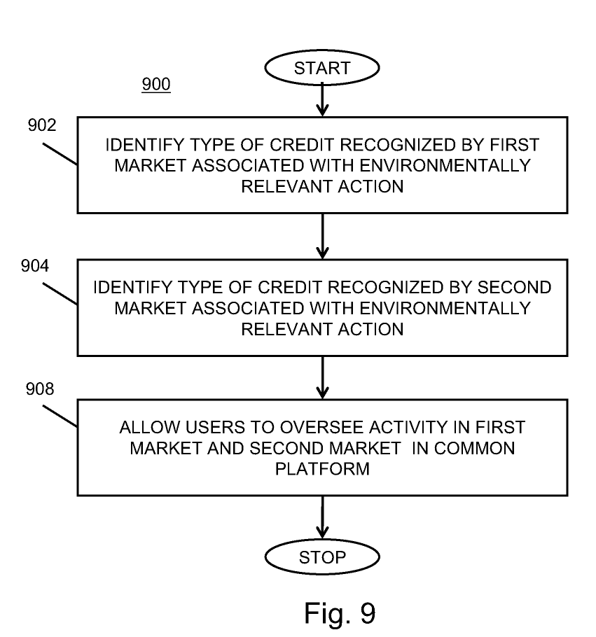

Referring to FIG. 9, an exemplary process 900 is illustrated for facilitating exchange of rights associated with environmentally relevant items 202. The process 900 may begin at step 902 where a type of credit recognized by a first market may be identified. In embodiments, the type of credit may be carbon emission reduction credits, carbon credits and the like. In embodiments, the first market may include industrial markets, voluntary markets, mandatory markets and the like. At step 904, a type of credit recognized by a second market may be identified. In embodiments, the type of credit may be associated with an environmentally relevant action. In embodiments, the second market may include industrial markets, voluntary markets, mandatory markets and the like. Finally at step 908, users may be allowed to oversee activity in the first market and the second market. In embodiments, the activities in the first market and the second market may be seen by the users in a common platform 104.

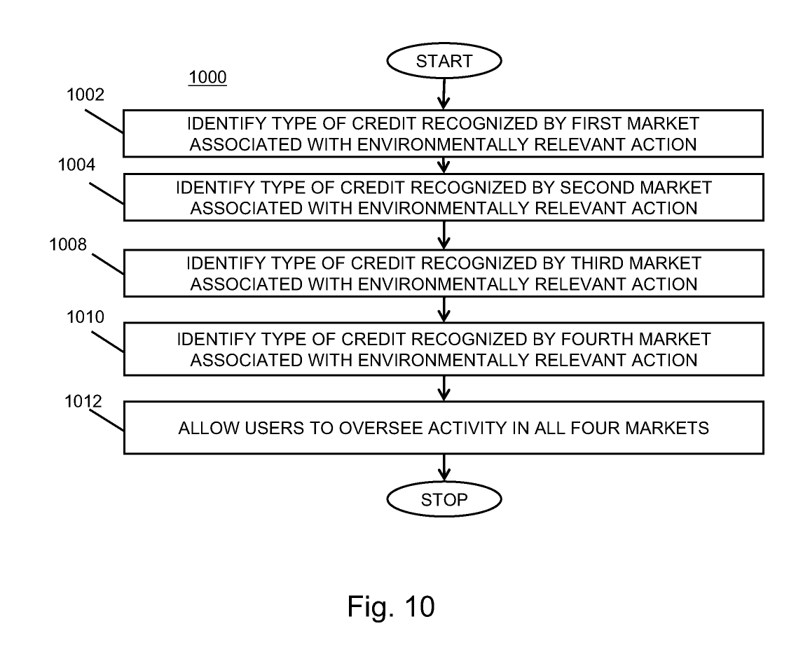

In embodiments, a process 1000 for facilitating the exchange of rights associated with environmentally relevant items 202 may be provided. In an example, environmentally relevant items 202 may be in form of carbon credits, emission allowance, and the like. Referring to FIG. 10, at step 1002, a type of credit recognized by a first market associated with an environmentally relevant action may be identified. The first market may be a REC market, industrial market, voluntary market, regulatory market, and the like. For example, a carbon credit, recognized by the renewable energy credit market industrial market and associated with an environmental security, say emission allowance, may be identified. The environmentally relevant action may also be buying, selling, exchanging, and the like. For example, the carbon credit may be associated with buying of carbon credits in the market.

Following this, at step 1004, another type of credit recognized by a second market associated with an environmentally relevant action may be identified. The second market may be an industrial market, voluntary market, regulatory market and the like. For example, a residential emission reduction credit, recognized by a voluntary market and associated with an environmental security, may be identified. In embodiments, the environmental security may be approved by a jurisdiction such as a pollution control department of a country or some other type of jurisdiction. In embodiments, the second type of credit may be associated with a different type of environmentally relevant action. Similarly, at step 1008, yet another type of credit recognized by a third market associated with an environmentally relevant action may be identified. The third market may be an industrial market, voluntary market, regulatory market and the like. Similarly, at step 1010, yet another type of credit recognized by a fourth market associated with an environmentally relevant action may be identified. Following this, at step 1012, users may be allowed to oversee activity in all four markets under a common platform. For example, the user may be allowed to oversee activity in either the renewable energy credit 218 market or an energy efficiency credit 220 market or a pollution reduction market or a carbon credit 222 market.

An exchange rate 120, multiplier, weighting, point-based system, score-based system or the like may allow for conversion between and/or comparison of an environmentally relevant item 202 with another environmentally relevant item 202 or a financial instrument, including, without limitation a security or commodity. In certain embodiments, the exchange rate 120, multiplier, weighting, point-based system, score-based system or the like may be determined by or associated with an exchange rate facility. The term “exchange rate” as used herein may include an exchange rate, a multiplier, a weighting, a point-based system, a score-based system and the like and the implementation of the exchange rate mechanism in the platform 104 and through the systems and methods described herein.

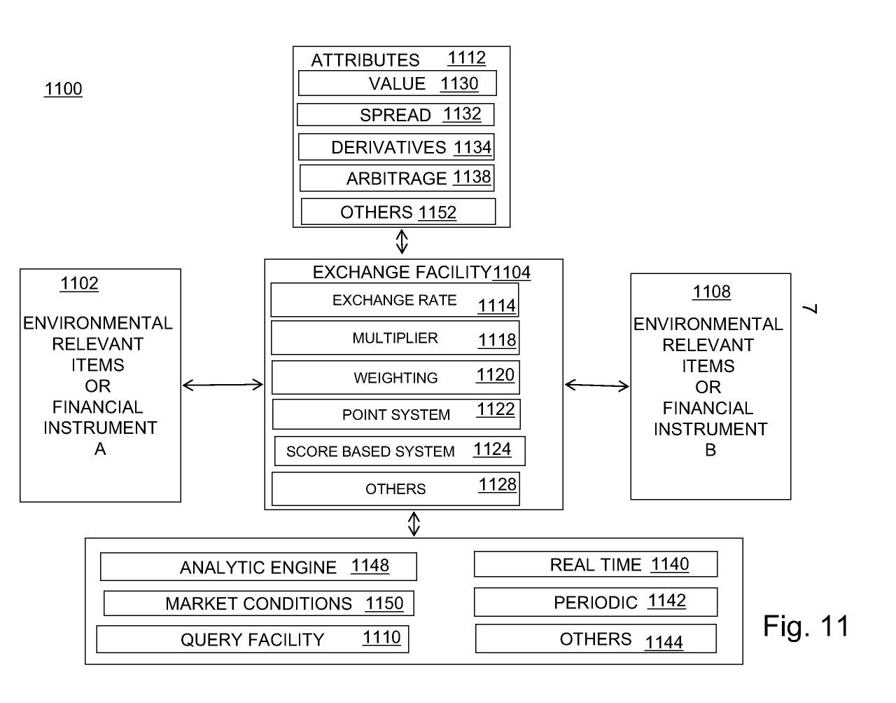

FIG. 11 depicts conversion and/or comparison of an environmentally relevant item 202 with another environmentally relevant item 202 or a financial instrument in accordance with an embodiment of the present invention. In embodiments, the platform 104 may include an exchange rate facility 1104. The exchange rate facility 1104 may determine, be associated with and/or provide an exchange rate 120, a multiplier 1118, a weighting 1120, a point-based system 1122, a score-based system 1124, and the like. The exchange rate facility 1104 may allow for conversion between or comparison of a first environmentally relevant item 202 or financial instrument with a second environmentally relevant item 202 or financial instrument, including, without limitation, a security or commodity. The exchange rate facility 1104 may also allow for comparisons and/or conversions of and among any number of environmentally relevant items 202 and/or financial instruments.

The exchange rate facility 1104 may analyze and consider various attributes 1112 of various environmentally relevant items 202 and/or financial instruments, including, without limitation, value 1130, spread 1132, derivatives 1134, arbitrage opportunities 1138 and other attributes 1139. An exchange rate 120 may be determined by the analytic engine 1148. An exchange rate 120 may be determined by the exchange rate facility 1104 in association with the analytic engine 1148. The exchange rate facility 1104 may be updated in real time 1140 or periodically 1142. The exchange rate facility 1104 may consider market conditions 1150 and other factors 1144. The exchange rate facility 1104 may be queried via a query facility 1110. An exchange rate 120 may be for conversion of one environmentally relevant item 202 to another. In an example, the environmentally relevant item 202 ‘A’ 1102 may be converted into a financial relevant item ‘B’ 1108 based on the exchange rate 120. In an embodiment, a REC 218 under the rules of one jurisdiction or protocol may be converted into a carbon offset pursuant to the rules of another jurisdiction. The exchange rate 120 may be for conversion of one environmentally relevant item 202 to a financial instrument, including, without limitation, a security or commodity. The exchange rate 120 may be for transfer of an environmentally relevant item 202 from one jurisdiction to another. The exchange rate 120 may be for transfer of an environmentally relevant item 202 from one application or regulatory or jurisdictional regime to another.

In an embodiment, the exchange rate 120 may be a currency exchange rate. In an embodiment, the exchange rate 120 may be a unit of measure conversion. The platform 104 may provide and/or determine the exchange rate 120, such as by using the analytic engine 1148. The exchange rate 120 may change with the market conditions 1150. Further, the exchange rate 120 may be updated in real time 1140 or may be updated periodically 1142. The exchange rate 120 may provide an indication of value of an environmentally relevant item 202. By using exchange rates 120, a net effect may be to have some or all environmentally relevant items 202 (such as RECs, EECs, CCs or others) in one common currency or measure. The exchange rate 120 may be used to calculate and/or determine the value 1130, or may actually be, the spread between two environmentally relevant items 202 or an environmentally relevant item 1102 and a financial instrument 1108, including, without limitation, a security or commodity. In an embodiment, the exchange rate 120 may call for the computation or creation of a derivative 1134 that allows a user to determine a REC to carbon-carbon avoidance measure associated with a REC. The exchange rates 120 may enable the arbitrage 1138 of the same environmentally relevant item 202 1102 type across different jurisdictions 272. For example, a Massachusetts REC and a Texas REC may not be valid in the other state's jurisdiction, but environmentally relevant items 202 and derivatives thereof allow swaps and arbitrage transactions to occur. The different jurisdictions 272 may be different international countries or markets. In another example, the creation of a derivative that enables trading around a carbon credit and the avoided carbon of a REC in the same or different jurisdictional region. In another embodiment, a regional greenhouse gas initiative (RGGI) carbon offset or allowance may not be valid in a western climate initiative (WCI) market system, but environmentally relevant items 202 and derivatives thereof may allow swaps and arbitrage transactions to occur.

An exchange rate 120 may be used to create derivative types of environmentally relevant items 202, such as an environmentally relevant item 202 relating to a different carbon footprint than the environmentally relevant items 202 from which it is derived. An exchange rate 120 may be associated with each attribute and/or groups of attributes 1112 of an environmentally relevant item 202. The overall exchange rate 120 for an environmentally relevant item 202 may be the sum of or other measure linked to the exchange rates relating to the various attributes of the environmentally relevant item 202. In this regard, a derivative environmentally relevant item 202 may be created based on certain attributes 1112 of a group of underlying environmentally relevant items 202 and financial instruments, including, without limitation, a security or commodity, and the exchange rate for the derivative environmentally relevant item 202 can be determined. This exchange rate 120 may be used to determine the value 1130 of the derivative environmentally relevant item 1102. In this manner custom or designer derivative environmentally relevant items 1102 may be created. The custom or designer derivative environmentally relevant item 1102 may be focused on a particular form of pollution, on a particular jurisdiction, on the technology and/or methods used for generation of any underlying environmentally relevant items 202 and the like. The exchange rates 120 relating to attributes of an environmentally relevant item 202 may be rolled up into various scores, views and the like.

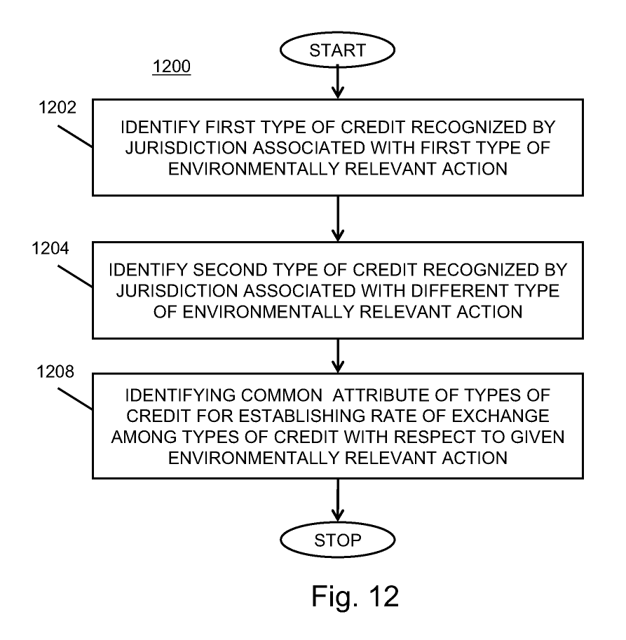

Referring to FIG. 12, a process 1200 is illustrated for facilitating exchange of rights associated with environmentally relevant items 202. The process 1200 may begin at step 1202 where a first type of credit recognized by a jurisdiction may be identified. The jurisdiction may include localities, states, sub-regions, regions, countries, international jurisdictions and the like. The first credit may be associated with a first type of environmentally relevant action. At step 1204, a second type of credit recognized by a jurisdiction may be identified. The second credit may also be associated with a different type of environmentally relevant action. Finally at step 1208, a common attribute of the credits may be identified. In embodiments, the common attribute of the credits may facilitate establishing a rate of an exchange among the types of credit with respect to the given environmentally relevant action.

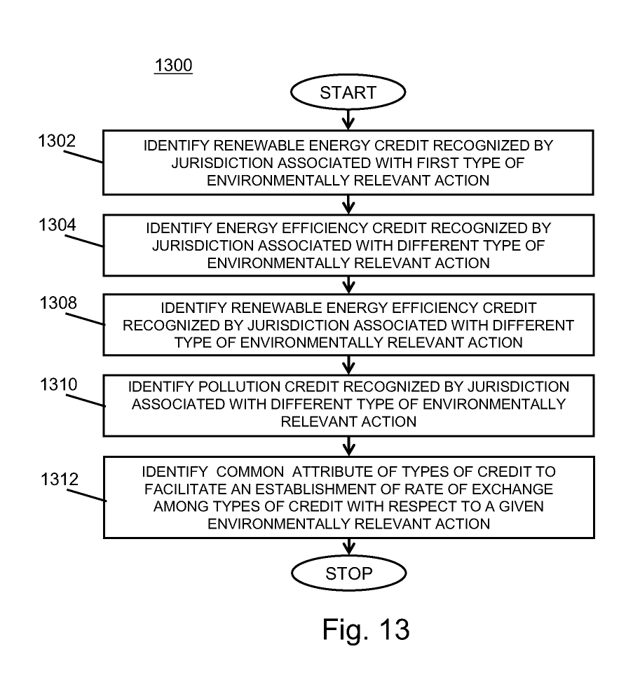

In embodiments, a method for facilitating exchange of rights associated with environmentally relevant items 202 may be provided. The method may be depicted by a process 1300 as shown in FIG. 13. In an example, environmentally relevant items 202 may be in form of carbon credits, emission allowances and the like. At step 1302, the process 1300 may identify a REC. In an example, the REC may be 1000 kWh of electricity generated from renewable energy sources such as wind, air, water, and some other types of renewable sources. Further, the renewable energy sources may be recognized from a jurisdiction, where the jurisdiction may include localities, states, sub-regions, regions, countries, international jurisdictions, and the like. In addition, the REC may be associated with a first type of environmentally relevant action. In an example, the first type of environmentally relevant action may be selling of environmentally relevant items 202.

At step 1304, an EEC may be identified. In an example, the EEC may be in the form of optimum utilization of energy. The EEC may be approved from an internationally recognized agency. Further, the EEC may be associated with different types of environmentally relevant actions. For example, a different type of environmentally relevant action may be the trading of environmentally relevant items 202. The process 1300 may further proceed to step 1308. At step 1308, a renewable energy efficiency credit may be identified. In embodiments, the renewable energy efficiency credit may be associated with a user of a specific type of renewable energy efficiency source such as solar energy. In addition, the renewable energy efficiency credit may be recognized by a jurisdiction that may be a region. In addition, renewable energy credit may be associated with a first type of environmentally relevant action. At step 1310, the process 1300 may identify a pollution reduction credit. Further, the pollution reduction credit may be approved by an international jurisdiction. In addition, the EEC may be associated with a different type of environmentally relevant action. In an example, the different type of environmentally relevant action may be clearing and/or retiring environmentally relevant items 202. Finally, at step 1312 of the process 1300, identification of common attributes for different types of credits may be provided. In an example, the credits may be carbon credits, emission allowances, and the like. The identification of different type of credits may facilitate establishing a rate of exchange among the different types of credits. In an example, the exchange rate among different type of credits may be based on currency or some other parameter. Additionally, the exchange rate among different type of credits may be based on environmentally relevant actions.

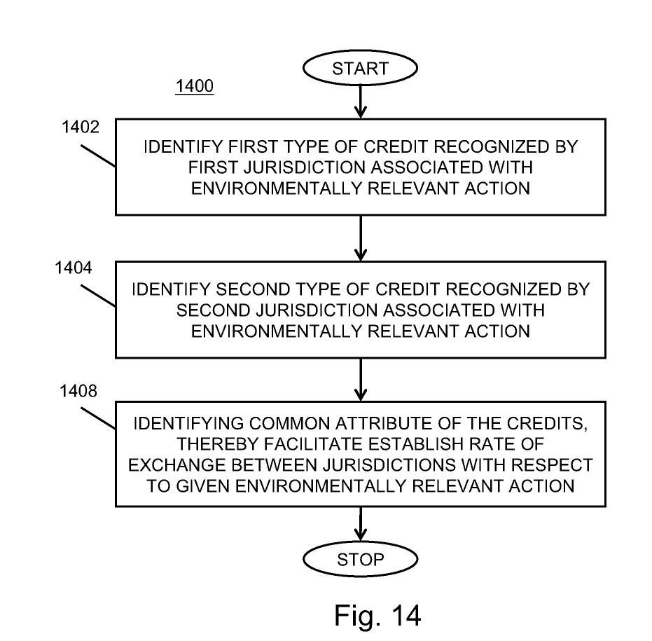

In an embodiment, an aspect of the present invention relates to a method for facilitating exchange of rights associated with environmentally relevant items 202. Referring to FIG. 14, a process 1400 is illustrated. The process 1400 may begin at step 1402 where a first type of credit recognized by a first jurisdiction may be identified. In embodiments, the first type of credit may be associated with an environmentally relevant action. In embodiments, the environmentally relevant action may be selling of environmentally relevant items 202. In embodiments, the first jurisdiction may include localities, states, sub-regions, regions, countries, international jurisdictions, and the like. At step 1404, a second type of credit recognized by a second jurisdiction such as localities, states, sub-regions, regions, countries, international jurisdictions, and the like, may be identified. In embodiments, the second type of credit may be associated with an environmentally relevant action. Finally at step 1408, a common attribute of the credits may be identified. In embodiments, the common attribute of the credits may facilitate establishing a rate of an exchange between the jurisdictions with respect to a given environmentally relevant action.

Derivatives may be created to enable the trading of environmentally relevant items 202 in various stages of origination or certification or verification, or to manage certain risk factors or to increase liquidity and fungibility. In an embodiment, a derivative 1134 or other financial instrument may be created that combines a carbon offset or project related emissions reduction that has not yet received certification with an insurance product to enable trading on the expectation that certification and verification will be completed. In the event that the certification is not received an insurance payout may be received. In another embodiment, a derivative product may enable the combination of a group of similar carbon credits into a single product to increase market liquidity and volume. In another embodiment, a derivative product may be an aggregation of different environmentally relevant items 202 including a combination of higher cost and lower cost credits to achieve a desired price point. In another embodiment, a derivative 1134 may consist of environmentally relevant items 202 with different expiration dates or associated time periods. The result may be a time diversified environmentally relevant item 202.

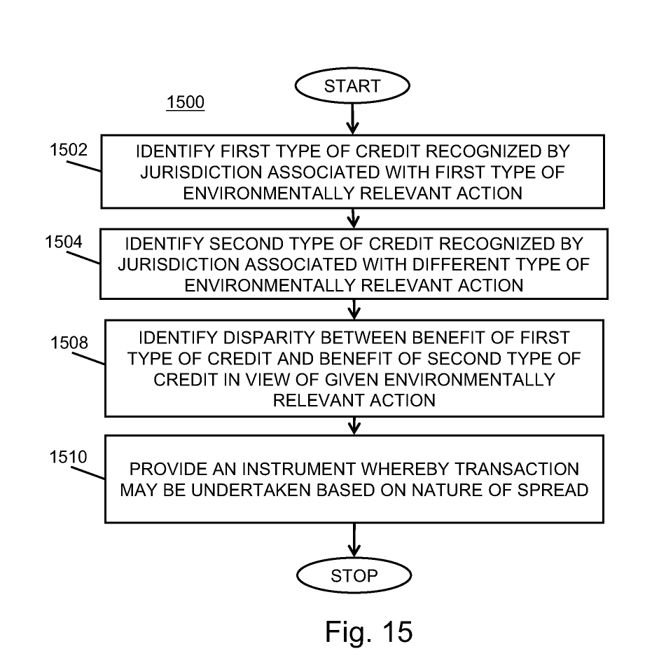

In embodiments, a process 1500 for facilitating exchange of rights associated with environmentally relevant items 202 may be provided. Referring to FIG. 15, at step 1502, a first type of credit associated with an environmentally relevant item 202 may be identified. For example, the first type of credit may be a carbon credit that may be recognized by a jurisdiction. The jurisdiction may be a locality, state, sub-region, region or nation with distinct regulatory and compliance authorities, and the like. In embodiments, the first type of credit may be associated with the first type of environmentally relevant action. The environmentally relevant action may be buying, selling, exchanging, trading, and the like. For example, the carbon credit may be associated with buying of carbon credits in the market. Following this, at step 1504, a second type of credit may be identified. For example, the second type of credit may be an emissions allowance provided to an organization for controlling pollution. In addition, the emission allowance may be approved by a jurisdiction such as a pollution control department of a country, European Union Emission Trading Scheme, or some other type of jurisdiction. In embodiments, the second type of credit may be associated with a different type of environmentally relevant action. For example, emission allowance may be associated with a different environmentally relevant action such as selling of emission allowance.

At step 1508, a disparity between the benefit of the first type of credit and the benefit of the second type of credit in view of a given environmentally relevant action may be identified. For example, a disparity between the benefits of carbon credit and emission allowance may be identified in view of buying of a certain credit. Following this, at step 1510, an instrument may be provided for a transaction based on the nature of the spread. For example, a transaction may be undertaken according to the disparity between the benefits of carbon credit and emission allowance. In embodiments, the transaction may involve imports and exports of credits. In embodiments, the transaction may involve emissions allocations purchased in an auction process. In an embodiment, the transaction may involve standing orders to buy and sell. In another embodiment, the transaction may be a forward transfer involving reconciliation. In yet another embodiment, the transaction may be a direct exchange. The transaction may be cross-jurisdictional, where the jurisdiction may be a locality, state, sub-region, region or nation with distinct regulatory and compliance authorities.

The platform 104 may include an analytic engine 1148. The analytic engine 1148 may perform analysis in connection with one or more environmentally relevant items 202. The analysis may be included in reports. The analytic engine 1148 may analyze a portfolio of environmentally relevant items 202. The analysis may include trading advice and recommendations. The analytic engine 1148 may generate a supply curve. The supply curve may be for one or more environmentally relevant items 202. The supply curve may be restricted by other parameters, such as jurisdiction. In an embodiment, a supply curve may show how many MWh produced by an independent systems operator. The analytic engine 1148 may generate a demand curve. The demand curve may be for one or more environmentally relevant items 202. The demand curve may be restricted by other parameters, such as jurisdiction. The analytic engine 1148 may assess obligations based on the load and the amount the load serving entity has served. The analytic engine 1148 may determine derivative measures, such as carbon avoided by use of a REC. The analytic engine 1148 may determine dependence on fuel for voluntary markets. The analytic engine 1148 may calculate offsets. The platform 104 may assist with calculation of offsets. The analytic engine 1148 may also determine remaining obligations by subtracting offsets, allocations and credits from an initial obligation.

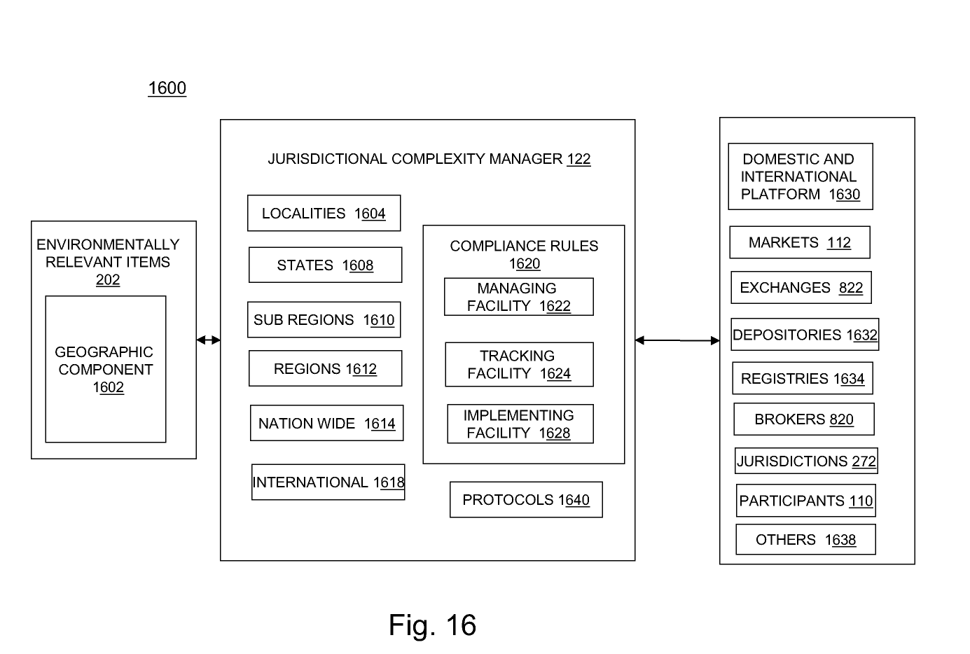

FIG. 16 depicts a jurisdictional complexity manager 122 in accordance with an embodiment of the present invention. The platform 104 may include a jurisdictional complexity manager 122. The jurisdictional complexity manager 122 may manage jurisdictional complexity, such as across localities 1604, states 1608, sub-regions 1610, regions 1612, nationwide 1614 and international 1618 jurisdictions. The jurisdictional complexity manager 122 may track, manage, and implement (possibly via a tracking facility 1624, managing facility 1622 and an implementation facility 1628, respectively) compliance rules for one or more jurisdictions 272, including classes and categories of commodities, securities or financial instruments; reporting requirements and reports; the timing of data exchange and data transfer; the rules regarding the trading periods of the marketplace within the jurisdiction; rules regarding the creation, tracking, and retirement of environmentally relevant items 202; rules regarding the banking and carry over of environmentally relevant items 202 from one trading period to the next; workflows and approval processes; tracking of environmentally relevant items 202 attributes across jurisdictions 272; tracking and validity of environmentally relevant items 202 created outside the jurisdiction to meet obligations within the jurisdiction; tracking of emissions and avoided carbon associated with environmentally relevant items 202 across jurisdictions 272 and the like. The jurisdictional complexity manager 122 may manage complexity across various protocols 1640. The jurisdictional complexity manager 122 may be used by and/or associated with a domestic and/or international platform or platforms 1630, markets 112, exchanges 822, depositories 1632, registries 1634, brokers 820, jurisdictions 272, participants 110 and others 1638, as shown in FIG. 16.

The jurisdictional complexity manager 122 may enable global distribution of US environmentally relevant items 202. The jurisdictional complexity manager 122 may enable international environmentally relevant items 202 to be distributed in the US. In an embodiment, the jurisdictional complexity manager 122 may enable EU-Emissions Trading Scheme Clean Development Mechanism/Joint Implementation carbon credits to be imported, tracked, distributed and transacted in United States markets 112. Jurisdictions 272 or localities 1604 may be relevant to an environmentally relevant item 202 and an exchange rate 120 may be useful for inter-jurisdictional analysis and conversion. In an embodiment, a different weight or multiple may be applied to a REC that is produced next to a load center than to one that is produced in a remote area. In another embodiment, a different weight or multiple may be applied to a REC produced using solar energy than to one produced using wind power or landfill gas. The jurisdictional complexity manager 122 may present tradeoffs across jurisdictions 272. The jurisdictional complexity manager 122 may be linked to the import/export manager 124 and cross-environmentally relevant item complexity manager 128. The jurisdictional complexity manager 122 may interface with other US or international platforms 1630, markets 112, brokers 820, exchanges 822 and jurisdictions 272.

Programs and qualifications for, and the laws, rules and regulations governing, the creation, administration, allowance and the like of environmentally relevant items 202 may vary by locality, state, sub-region, region and country. In addition, local, state, regional, federal and international jurisdictions 272 may overlap in some respects but not in others. For example, jurisdictions 272 may vary regarding which industries and which emissions are regulated, which forms of renewable energy are promoted in jurisdiction and which forms of energy efficiency are promoted in the jurisdiction. As a result the jurisdictional complexity manager may assist with jurisdictional qualification management. As different entities may qualify as generators in different jurisdictions 272, the jurisdictional complexity manager 122 may assist with qualifying generators and environmentally relevant items 202. As different energy sources and environmentally relevant items 202 are relevant to different jurisdictions 272, the jurisdictional complexity manager 122 may assist with qualifying energy sources and environmentally relevant items 202. The platform 104 may take these factors into account and may update the information concerning these factors in real time, at set intervals, on demand and/or periodically.

In an embodiment, the jurisdictional complexity manager 122 may manage the jurisdictional complexity of RECs, energy efficiency and carbon commodities. In an embodiment, the jurisdictional complexity manager 122 may manage jurisdictional complexity across multiple states for carbon. In an embodiment, the platform 104 may cover different environmentally relevant items 202 in different jurisdictions 272 and among different protocols 1640. The platform 104 may enable tracking of common attributes and/or at least a common denominator among different protocols 1640 and/or jurisdictions 272. The jurisdictional complexity manager 122 may determine exchange rates 120 across jurisdictions 272 and/or protocols 1640. The jurisdictional complexity manager 122, alone or in conjunction with other aspects of the platform 104, may assist with avoidance of double counting. The jurisdictional complexity manager 122 may enable environmentally relevant items 202 to have geographic component 1602. In an embodiment, a voluntary participant may want to have an environmental impact in certain regions, such as plant locations or regions with customers and the jurisdictional complexity manager 122 may facilitate this selective impact. In an embodiment, a voluntary participant may want to have an environmental impact in certain regions, such as plant locations or regions with customers in a particular jurisdiction and the jurisdictional complexity manager 122 may facilitate this selective impact. In embodiments, the jurisdictional complexity manager 122 may interface with domestic or international platforms 1630, markets 112, exchanges 822, depositories 1632, registries 1634, brokers 820, jurisdictions 272, participants 110, others 1638, and the like.

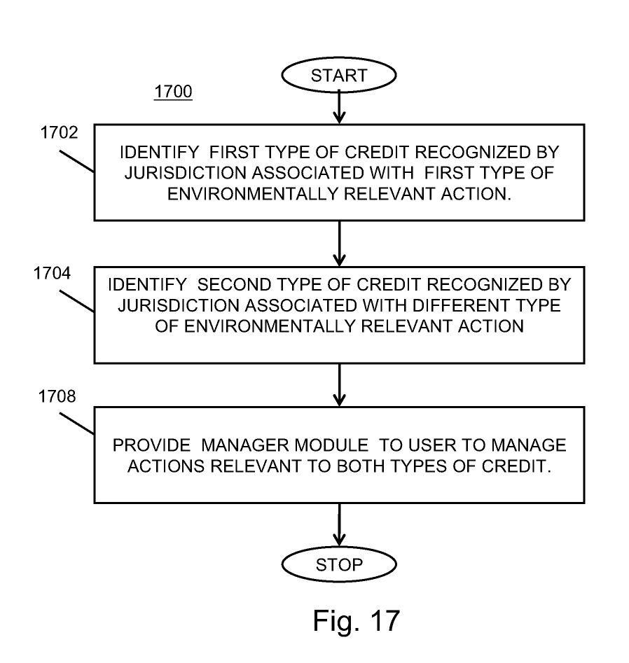

In embodiments, a method for facilitating exchange of rights associated with environmentally relevant items 202 may be provided. The method may be depicted by a process 1700 as shown in FIG. 17. In an example, environmentally relevant items 202 may be in form of carbon credits, emission allowance, and the like. Further, an environmentally relevant item 202 may be an emission allowance. Referring to FIG. 17, at step 1702, the process 1700 may identify a first type of credit associated with the environmentally relevant item 202. In an example the first type of credit may be a carbon credit that may be recognized by a jurisdiction. In an example, a jurisdiction may be a locality, state, sub-region, region or nation with distinct regulatory and compliance authorities, and the like. In addition, the process 1700 may associate the first type of credit with the first type of environmentally relevant action. The environmentally relevant action may be buying, selling, exchanging, and the like. For example, the first type of environmentally relevant action may be buying of carbon credits in the market.

Further, at step 1704, the process 1700 may identify a second type of credit. In an example, the second type of credit may be an emissions allowance provided to an organization for controlling pollution. Further, the emission allowance may be approved by a jurisdiction such as a pollution control department of a country, European Union Emission Trading Scheme, or some other type of jurisdiction. Furthermore, at step 1704 of the process 1700, the second type of credit may be associated with a different type of environmentally relevant action. In an example, an emission allowance may be associated with a different environmentally relevant action such as the selling of an emission allowance. At step 1708, a manager module, such as the jurisdictional complexity manager 122, may be provided for managing actions related to both type of credits. Alternatively, the manager module may be associated with the jurisdictional complexity manager 122. The jurisdictional complexity manager 122 may manage jurisdictional complexity, such as across localities 1604, states 1608, sub-regions 1610, regions 1612, nationwide 1614 and international 1618 jurisdictions 272. The manger module may provide a user with an ability to manage actions for different type of credits. In an example, the manager module may allow the user to manage the first type of environmentally relevant credit and the second type of environmentally relevant credit. For example, the first type of environmentally relevant credit may be a carbon credit and the second type of environmentally relevant credit may be an emissions allowance.

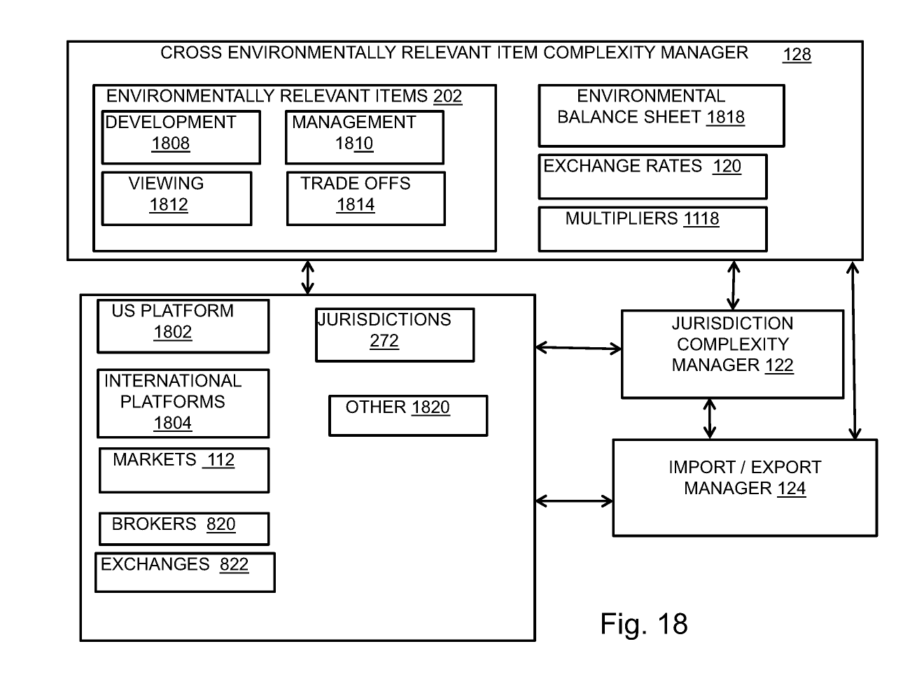

FIG. 18 depicts a cross-environmentally relevant item complexity manager 128 in accordance with an embodiment of the present invention. The platform 104 may include a cross-environmentally relevant item complexity manager 128. The cross-environmentally relevant item complexity manager 128 may allow for management of all types of environmentally relevant items 202. The cross-environmentally relevant item complexity manager 128 may interface to at least one US platform 1802, international platform 1804, market 112, broker 820, exchange 822, jurisdiction 272 or other platforms 1820. The cross-environmentally relevant item complexity manager 128 may be linked to the import/export manager 124 and jurisdictional complexity manager 122. The cross-environmentally relevant item complexity manager 128 may allow for the development 1808, management 1810 and viewing 1812 of a full portfolio of environmentally relevant items 202. The cross-environmentally relevant item complexity manager 128 may enable creation of an environmental balance sheet 1818. The cross-environmentally relevant item complexity manager 128 may create or utilize exchange rates 120 or multipliers 1118 for comparison and conversion of environmentally relevant items 202. The cross-environmentally relevant item complexity manager 128 may present tradeoffs 1814 across environmentally relevant items 202. The cross-environmentally relevant item complexity manager 128 may interface with a US platform 1802, international platform 1804, market 112, broker 820, exchange 822, jurisdiction 272 or other platform 1820. The cross-environmentally relevant item complexity manager 128 may interface with depositories 1632, registries 1634, participants 110, and the like.

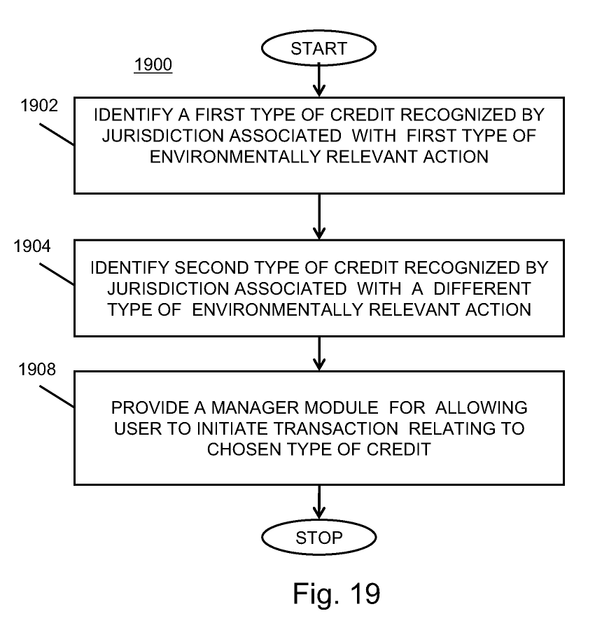

Referring to FIG. 19, a process 1900 for facilitating exchange of rights associated with environmentally relevant items 202 is illustrated. The process 1900 may begin at step 1902, where a first type of credit recognized by a jurisdiction may be identified. In embodiments, the credit may be associated with the first type of environmentally relevant action. Further, at step 1904, a second credit recognized by a jurisdiction may be identified. In embodiments, the second credit may be associated with a different type of environmentally relevant action. Finally at step 1908, a manager module, such as a cross-environmentally relevant item complexity manager 128, may be provided. In embodiments, the manager module may be used by a user to manage actions relevant to both types of credit. In other embodiments, the manager module may allow the user to initiate transaction. In embodiments, the transaction may be related to a chosen type of credit. The transactions may include creating, tracking, auctioning, buying, selling, trading, clearing, retiring and other types of transactions.

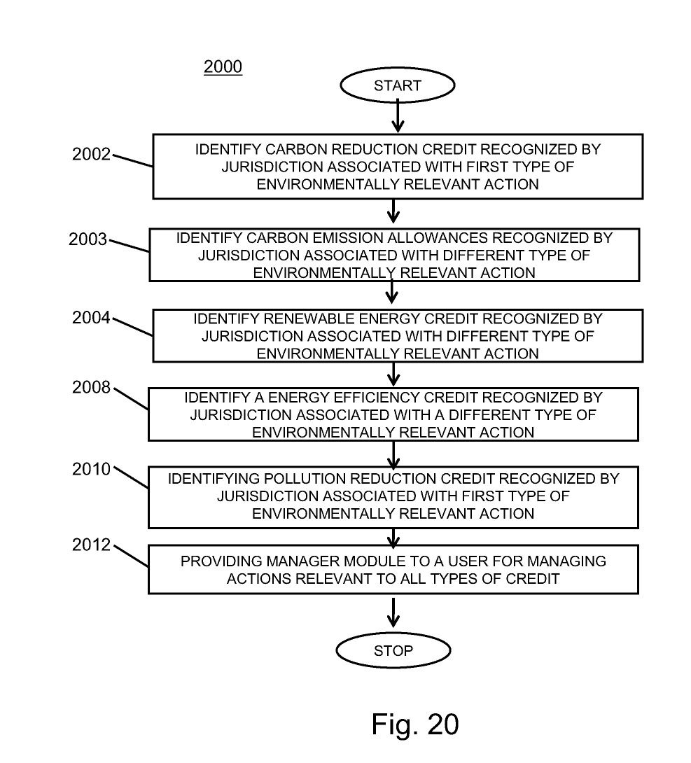

In embodiments, a method for facilitating exchange of rights associated with environmentally relevant items 202 may be provided. The method may be depicted by a process 2000 as shown in FIG. 20. In an example, environmentally relevant items 202 may be carbon credits, emission allowances, and the like. Further, the facilitation of the exchange of rights may involve exchanging environmentally relevant items 202. In an example, the environmentally relevant items 202 may be an emission allowance. At step 2002, the process 2000 may identify a carbon reduction credit. The carbon reduction credit may be approved by a jurisdiction. Additionally, the carbon reduction credit may be associated with a first type of environmentally relevant action such as an action of buying environmentally relevant items 202. At step 2003, the process 2000 may identify a carbon emissions allowance. The process 2000 may further proceed to step 2004, where a renewable energy credit may be identified. In an example, the renewable energy credit may be 1000 kWh of electricity generated from renewable energy sources. Further, the renewable energy source may be recognized from a jurisdiction. In an example, a jurisdiction may include a specific country. In addition, a renewable energy credit may be associated with a different type of environmentally relevant action. In an example, the different type of environmentally relevant action may be selling of environmentally relevant items 202.

At step 2008, an energy efficiency credit may be identified. In an example, the energy efficiency credit may be in form of an energy reduction credit. Further, the energy efficiency credit may be approved by an internationally recognized agency. Furthermore, the energy efficiency credit may be associated with different types of environmentally relevant actions. In an example, the different type of environmentally relevant action may be trading of environmentally relevant items 202. At step 2010, the process 2000 may identify a pollution reduction credit. Further, the pollution reduction credit may be approved from an international jurisdiction. In addition, the energy efficiency credit may be associated with different types of environmentally relevant action. In an example, the different type of environmentally relevant action may be clearing and/or retiring environmentally relevant items 202. Finally at step 2012, a manger module may be provided. The manager module may provide management of all types of actions associated with a user. In an example, the user may manage buying, selling, trading or some other type of user action, using the manager module.

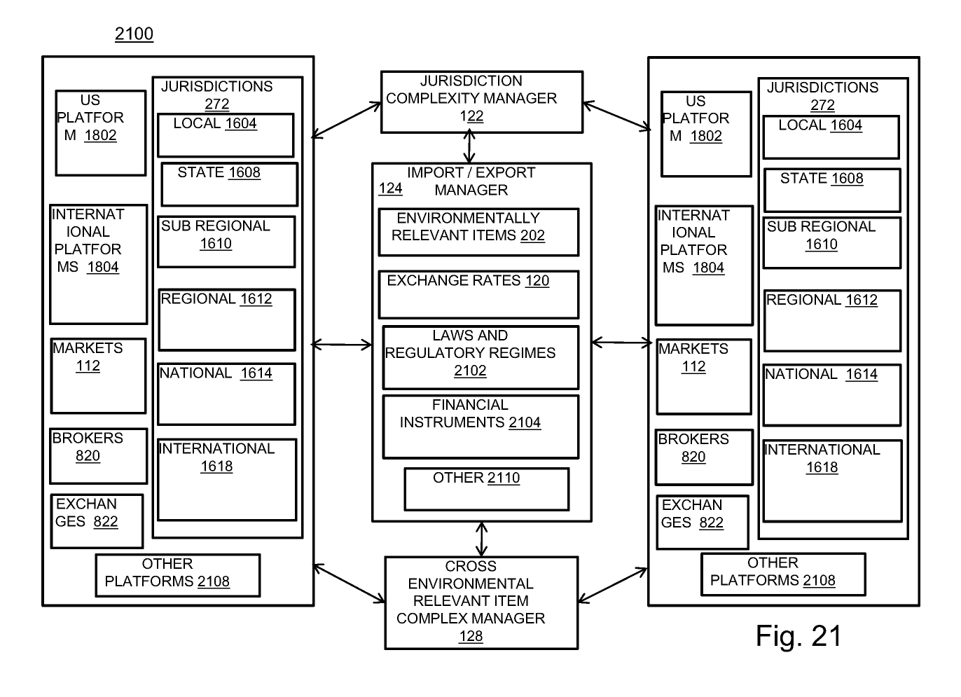

FIG. 21 depicts an import/export manager 124 in accordance with an embodiment of the present invention. The platform 104 may include an import/export manager 124. The import/export manager 124 may manage imports and/or exports of environmentally relevant items 202. The import/export manager 124 may interface with at least one other US platform 1802 or international platform 1804, market 112, broker 820, exchange 822, jurisdiction 272 or some other platform 2108. The import/export manager 124 may enable transfer of environmentally relevant items 202 from one platform/system 104 to another. The import/export manager 124 may be associated with environmentally relevant items 202, exchange rates 120, laws and regulatory regimes 2102, financial instruments 2104, others 2110, and the like. The import/export manager 124 may enable transfer of environmentally relevant items 202 from one jurisdiction to another, including local 1604, state 1608, sub-regional 1610, regional 1612, national 1614 and international jurisdictions 1618. The import/export manager 124 may utilize exchange rates 120. The import/export manager 124 may account for differences in applicable laws and regulatory regimes 2102. The import/export manager 124 may manage the import and/or export of financial instruments 2104. The import/export manager 124 may be combined with the jurisdictional complexity manager 122 and the cross-environmentally relevant item complexity manager 128.

The platform 104 may include a workflow manager. The workflow manager may allow for the creation, management and monitoring of workflows. In an embodiment, the workflow manager may allow for the creation of a workflow for generating a new environmentally relevant item 202. The workflow manager may specify the sequence of steps through which an environmentally relevant item 202 is created and verified. The workflow manager may enable the sequence of steps in a workflow to be configured and implemented in a manner customized to the needs of a particular jurisdiction, institution or the like. The workflow manager may monitor progress through the various steps and may send alerts once certain steps are complete. In an embodiment, the workflow manager may send event, calendar, and workflow triggered email messages and alerts. This may include event-driven distribution of information to relevant parties with appropriate access rights, based on the desired workflow. In another embodiment, the workflow manager may manage the steps involved in transferring an environmentally relevant item 202 from one party to another.

The workflow manager may include a document management facility. The document management facility may include the ability to track various versions and types of documents associated with each environmentally relevant item 202. The document management facility may provide a feature for the serial number based lookup and searching of each environmentally relevant item 202, so that documents related to each serialized item can be retrieved by the owner of the environmentally relevant item 202 for the lifetime of a program.

The platform 104 may include a registry. The registry may be a registry of environmentally relevant items 202. The registry may be a registry of transactions involving environmentally relevant items 202. The registry may be a registry of creation, origination, certification, verification and/or retirement of environmentally relevant items 202. The registry may be a registry of generators (including entities, companies, individuals and the like) of environmentally relevant items 202, buyers and traders of environmentally relevant items 202 and the like. The registry may cover various environmentally relevant items 202. The registry may cover various jurisdictions, may link up registries of various localities, states, sub-regions, regions or countries and/or may link up many different markets into one platform. The registry may function to prevent double counting and limit green-washing. The registry may take into account mandatory and/or voluntary markets. The registry may be hosted. The registry may be deployed at a corporate level to track environmentally relevant items 202, obligations and emissions for a firm. The registry may be deployed for a broker, marketer or financial institution to track environmentally relevant items 202, obligations or emissions for multiple clients. The registry may be deployed for a local, sub-regional, regional, state or national market or exchange to track environmentally relevant items 202, obligations or emissions for multiple companies.

The platform 104 may include a market depository. The market depository may be an environmental market depository. The market depository may be for various environmentally relevant items 202. In an embodiment, the market depository may be one depository for RECs, EECs, CCs, carbon emission reduction credits and other environmentally relevant items 202. The market depository may be deployed at a corporate level to track environmentally relevant items 202, obligations or emissions for a firm. The market depository may be deployed for a broker, marketer or financial institution to track environmentally relevant items 202, obligations or emissions for multiple clients. The market depository may be deployed for a locality, sub-region, region, state, or national market or exchange to track environmentally relevant items 202, obligations or emissions for multiple companies. In embodiments, the market depository may be a mechanism to link multiple localities, sub-regions, regions, states, or national markets or exchanges to track and transact environmentally relevant items 202. The market depository may be used as a single point of information and integration and as a custodial service by banks, brokers, marketers exchanges and other participants who may operate and transact environmentally relevant items 202 across jurisdictions and markets. The market depository may be used to track, manage, and record intermediate transactions for environmentally relevant items 202 across multiple registries. In an embodiment, the market depository may be a unifying data and transaction infrastructure across markets.

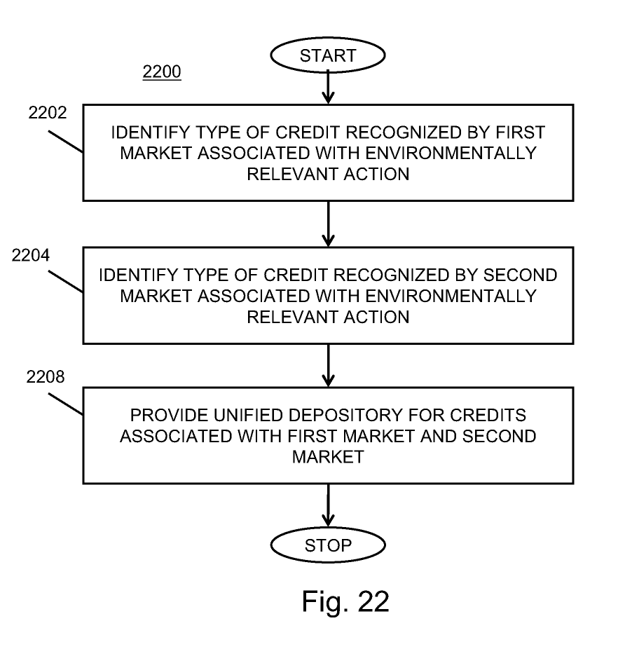

Referring to FIG. 22, an exemplary process 2200 is illustrated for facilitating exchange of rights associated with environmentally relevant items 202. The process 2200 may begin at step 2202, where a type of credit recognized by a first market may be identified. In embodiments, the type of credit may be carbon emission reduction credits, emission allowances and the like. In embodiments, the type of credit may be associated with an environmentally relevant action. In embodiments, the first market may include industrial markets, voluntary markets, mandatory markets and the like. In a similar manner, a type of credit recognized by a second market may be identified at step 2204. In embodiments, the type of credit may be associated with an environmentally relevant action. In embodiments, the second type of credit may be carbon emission reduction credits, emission allowances, and the like. In embodiments, the second market may include industrial markets, voluntary markets, mandatory markets and the like.

Finally at step 2208, a unified depository for credits may be provided. In embodiments, the credits may be associated with the above first markets and the second markets. For example, the unified depository for credits may be a market depository. In other embodiments, the market depository may be an environmental market depository. In an example, the market depository may be for various environmentally relevant items 202. In an embodiment, the market depository may be one depository for RECs, EECs, CCs, carbon emission reduction credits and other environmentally relevant items 202.

The platform 104 may include a compliance facility. The compliance facility may assess and/or enforce compliance with a particular law, rule, regulation and/or regulatory regime. The compliance facility may assess the extent to which a firm has achieved certain emissions, renewable energy, energy efficiency or other obligations or goals, in compliance with one or more laws, rules, regulations and policies. The compliance facility may assess compliance with a strategy, set or rules or policies, internal corporate controls or policies, a trading policy and the like. In an embodiment, the compliance facility may monitor whether employees or traders representing a company are trading in accordance with the policies of the marketplace, jurisdiction or company. In another embodiment, a compliance facility may ensure compliance by participants in a regulated market and a voluntary market for environmentally relevant items 202. The compliance facility may assess and/or enforce local, state, sub-regional, regional, national and international compliance. The compliance facility may generate compliance reports for users of the platform, regulators and the like. Verification and certification companies may assist or interact with the compliance facility, and may use the compliance facility to enter and verify information on behalf of third parties. Market and other regulators may use the compliance facility to track and monitor activities of the marketplace generally, specific aspects or specific participants in the marketplace. The compliance facility may generate alerts or reports when there is non-compliance. The compliance facility may assess and/or enforce compliance in real-time, periodically, on command or at set-intervals, such as on a schedule.

The platform 104 may include a trading engine. The trading engine may facilitate buying and/or selling environmentally relevant items 202. The trading engine may also facilitate the creation and/or retirement of environmentally relevant items 202. The platform 104 may function similar to a stock exchange, but for environmentally relevant items 202. The trading engine may allow participants to advertise environmentally relevant items 202 for sale or demand for environmentally relevant items 202, but have the platform 104 facilitate the transaction. The trading engine may enable trading of environmentally relevant items 202 for other environmentally relevant items 202 or financial instruments, including, without limitation, securities and commodities. The trading engine may enable buying and selling of environmentally relevant items 202 for monetary instruments, such as cash, stocks and the like. In certain embodiments, the platform 104 may include a buying network on top of a local, state, sub-regional, regional, national or international market system. In certain embodiments, the platform 104 may be a private buying network for a corporation or financial institution and its clients, facilitating transactions between the client of the corporation or financial institution as well as external markets in environmentally relevant items 202. In certain embodiments, the platform 104 may be separate from the actual exchange and may merely enable the creation, tracking, retirement, transfers between accounts, and ownership tracking functionality, but another entity is responsible for trading, clearing and settling transactions. In certain embodiments, the platform 104 may allow for management of the timing of trades and/or transactions.

The platform 104 may include a credit and clearing engine. The credit and clearing engine may allow for the clearing of transactions. The credit and clearing engine may facilitate the process of settling a trade or transaction. The credit and clearing engine may facilitate the activities from the time a transaction is made until it is settled. The credit and clearing engine may facilitate the verification of information between the two parties to a transaction and the subsequent settlement. The platform 104 may allow for market clearing as opposed to only bilateral transactions. The platform 104 may allow a third party to be the clearing agent.

The platform 104 may include a timing manager. The timing manager may allow the entry of an environmentally relevant item 202 into the market to be timed or scheduled. The timing manager may allow the entry of an environmentally relevant item 202 to be de-coupled from the actual time of generation, which may increase efficiency since it may avoid the need to shut down a plant and the like. The timing manager may allow timing with respect to on-peak and/or off-peak periods. The timing manager may allow retirement of an environmentally relevant item 202 to be timed. The timing manager may assist with the timing of trades and clearing.

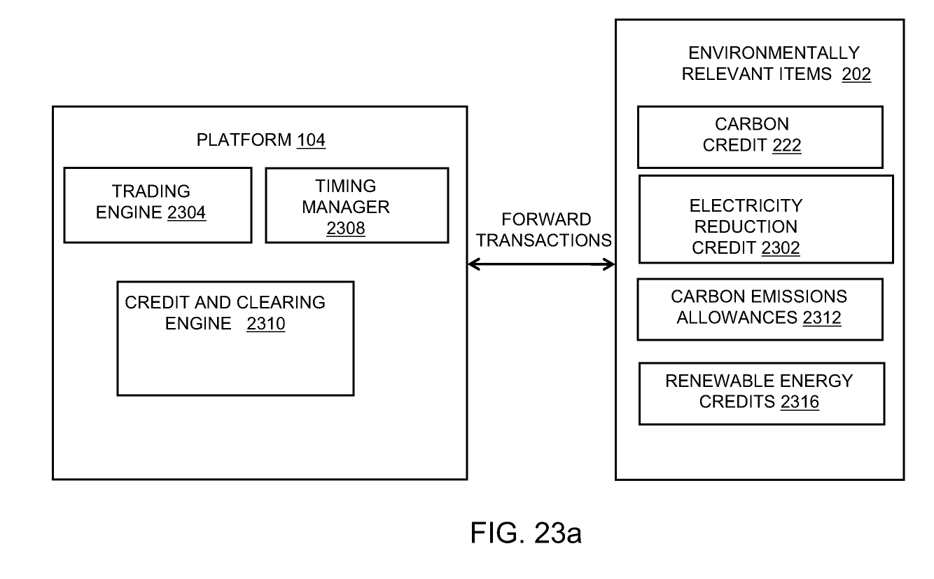

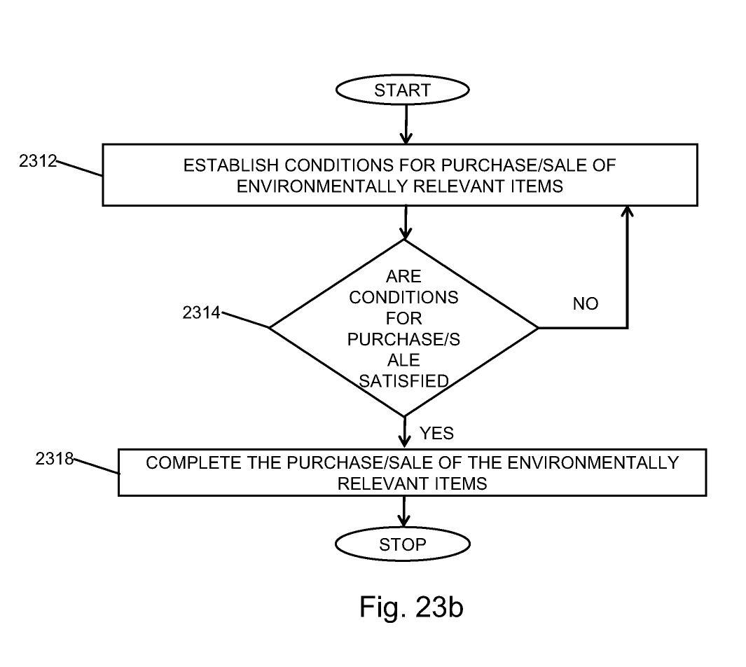

As depicted in FIG. 23a, the platform 104, possibly involving a trading engine 2304, credit and clearing engine 2310 and timing manager 2308, may enable forward transactions and/or standing orders. The platform 104 may execute instructions regarding the pricing and volumes at which to buy environmentally relevant items 202 over set periods, at regular intervals, at define dates and the like. The platform 104 may also enable standing sales. The platform 104 may execute instructions regarding pricing and volumes at which to sell environmentally relevant items 202 over set periods, at regular intervals, at define dates, and the like. Examples of environmentally relevant items 202 may include a carbon credit 222, an electricity reduction credit 2302, a carbon emissions allowance 2312, a renewable energy credit 2316, and the like. The platform 104 may also enable standing sales. The platform 104, possibly involving the trading engine, credit and clearing engine and timing manager, may enable forward transactions. A forward transaction may be an arrangement to buy or sell an environmentally relevant item 202 at some specific time in the future. The platform 104 may provide a process and/or methodology to settle and reconcile forward transactions for environmentally relevant items 202. In an aspect of the present invention the forward transaction may be understood by an example such that the trading engine 2304 may specify a condition that if the volume for trading carbon credits 222 in a three hour period exceeds 10,000 units, the platform 104 may purchase 100 units of carbon credits. The trading engine 2304 may use the timing manager 2308 for specifying the three hour period. In another example, the forward transaction may be such that the trading engine 2304 specifies a condition that an electricity reduction credit 918 may be sold if the price per unit exceeds a set dollar threshold during peak energy usage hours in California.

FIG. 23b depicts a process for the sale/purchase of environmentally relevant items 202 in accordance with an embodiment of the present invention. In an embodiment, the platform 104 may provide the process and/or methodology to settle and reconcile forward transactions for environmentally relevant items 202. At step 2312, conditions for purchase/sale of environmentally relevant items 202 may be established. The conditions may be established by the platform 104. The trading engine 2304 may establish the conditions in conjunction with the timing manager 2308 and the credit and clearing engine 2310. In an example, the condition may be that if the price per unit of the electricity reduction credit 2302 exceeds a set dollar threshold during non-peak energy usage hours in California, the electricity reduction credit 2302 may be sold/purchased. At step 2314, it may be checked whether the conditions established at step 2312 are satisfied. In an embodiment, at step 2318, an environmentally item for which a condition has been satisfied in step 2314 is sold/purchased. In case, the condition is not satisfied at step 2314, the step 2314 may proceed to step 2312. In an example, the electricity reduction credit 2302 may be sold by the platform 104, if the electricity reduction credit 2302 exceeds the set dollar threshold during non-peak energy usage established at step 2312. In an embodiment, the trading engine 2304 in the platform 104 may sell the electricity reduction credit 2302.

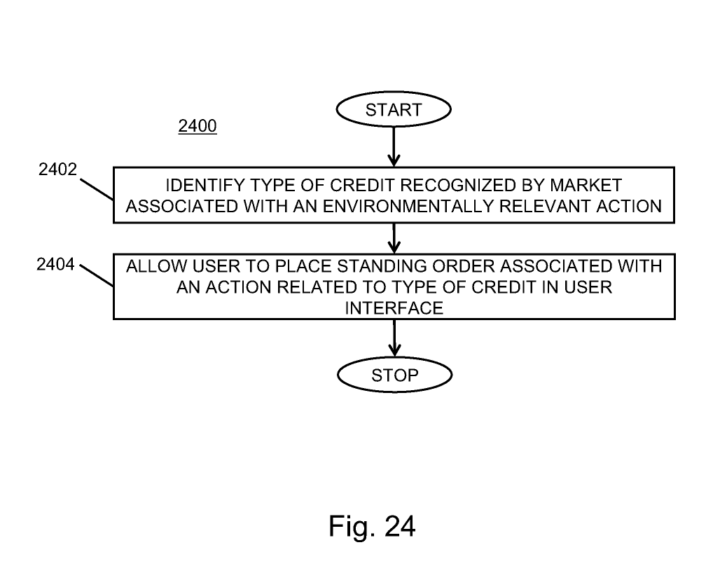

In embodiments, a method 2400 for facilitating exchange of rights associated with environmentally relevant items 202 may be provided. In an example, environmentally relevant items 202 may be in the form of carbon credits, emission allowances and the like. Referring to FIG. 24, at step 2402, a type of credit recognized by a market associated with an environmentally relevant action may be identified. The type of credit may be a REC, TRC, EEC, a carbon reduction credit, a pollution reduction credit, a carbon offset such as a VER or CER or ERU or VCU, an emissions allowance, an energy conservation credit, a carbon avoidance credit/certificate, a residential emission reduction credit, a tradable residential emission reduction credit, a residential renewable energy certificate, a tradable residential renewable energy certificate, a carbon credit or offset or emission allocation, a renewable obligation certificate, a water credit, water permit, mercury allowance or permit, or a credit relating to other markets, and the like. Following this, at step 2404, a user may be allowed to place an order associated with an action related to the type of credit. In embodiments, the user can place the order using a user interface or a dashboard 200. Further, the action may be buying, selling, exchanging, and the like.

The platform 104 may include a verification engine. The verification engine may verify information concerning environmentally relevant items 202. The verification engine may verify attributes of environmentally relevant items 202, including information regarding their origin, location, dates, attributes, quantities, amounts, jurisdictional qualifications and the like. The verification engine may verify information concerning users of the platform 104 and market participants. The verification engine may verify information concerning plants or sites that are the origin of the environmentally relevant items 202. The verification engine may verify information concerning transactions involving environmentally relevant items 202, such as information relating to trades or retirement of environmentally relevant items 202. The verification engine may enable auditing, such as through the data archive and audit trail. The verification engine may allow for document management. The verification engine may allow for attestations and may store, generate or provide evidence concerning information that was verified. A certified third party may enter information or may verify information. In an embodiment, a certified third party may be provided with an electronic interface in order to report a generator's output as verified by the certified third party. The verification engine may use data directly sourced from meters. The verification engine may use data from file transfers from a trusted source. The verification engine may track and/or utilize metadata surrounding verification, such as who performed the verification, how verification was performed, which protocol was used for verification and the like. The verification engine may make documentation, photographs and attestation available in a web environment. The verification engine may be used to create branding. In an embodiment, the verification engine may enable tagging or branding of items, services and/or environmentally relevant items 202 as verified as green.

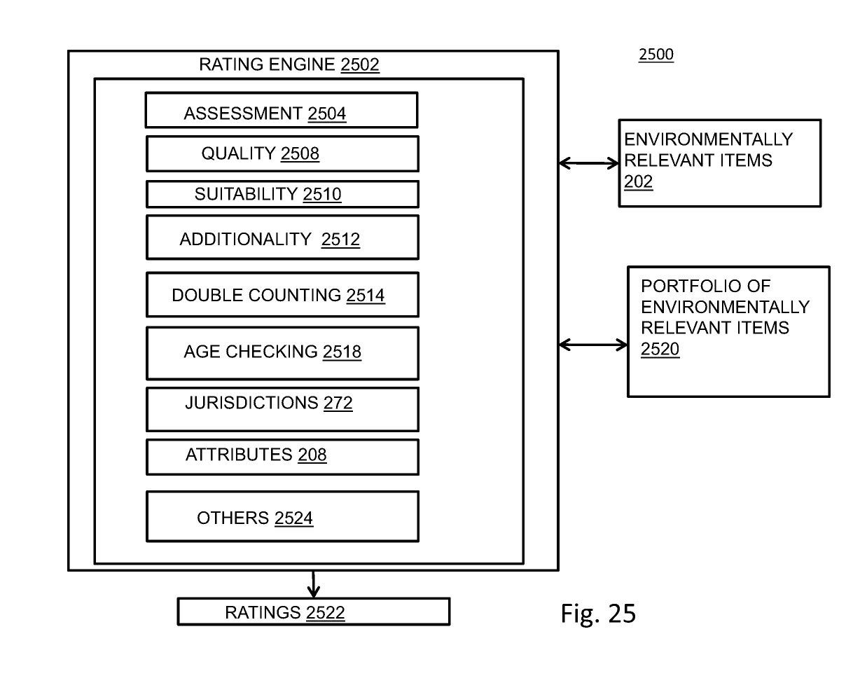

FIG. 25 depicts a rating engine 2502 for rating of environmentally relevant items 202 in accordance with an embodiment of the present invention. The platform 104 may include a rating engine 2502. The rating engine 2502 may include assessment 2504 or quality 2508, suitability 2510, additionality 2512, double counting 2514, age 2518, jurisdiction parameters 272, attributes 208, others 2524, and the like. The rating engine 2502 may assess the environmentally relevant items 202. In embodiments, the rating engine 2502 may assess the quality 2508 of environmentally relevant items 202. In embodiments, the rating engine 2502 may assess the suitability 2510 of environment relevant items 202. The rating engine 2502 may assess the suitability 2510 of the environmentally relevant items 202 for achieving a compliance objective, a voluntary objective, and some other type of objective. In embodiments, the rating engine 2502 may take into account factors such as the likelihood that the environmentally relevant items 202 have been greenwashed 2512 and/or double-counted 2514, age 2518 of the environmentally relevant item 202, jurisdictions 272 of generation of the environmentally relevant item 202, quality 2508 and attributes 208 of the environmentally relevant items 202, and the like. In embodiments, the rating engine 2502 may take into account other characteristics of the environmentally relevant items 202 by others 2524, as depicted in FIG. 25. Furthermore, the rating engine 2502 may rate and/or assess a portfolio of environmentally relevant items 2520. The ratings 2522 of the rating engine 2502 may function as a measurement system for the quality of RECs, EECs, CCs or other environmentally relevant items 202. In an embodiment, the measurement system may be a star-based or alphanumeric rating system. The measurement system may involve a continuum of quality for environmentally relevant items 202.

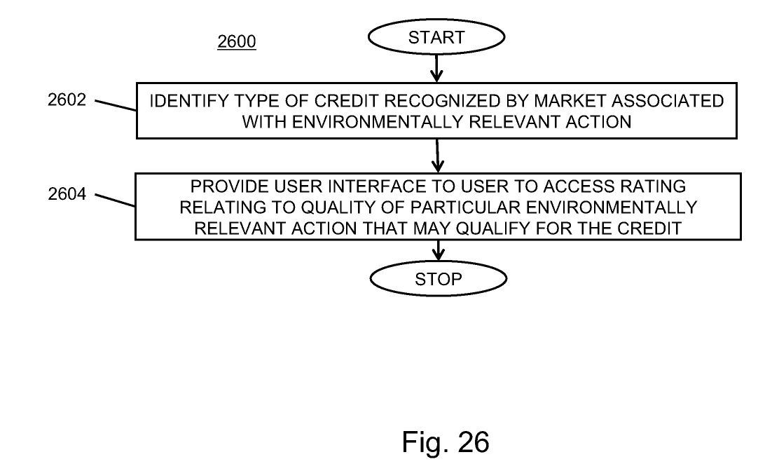

In embodiments, a method 2600 for facilitating exchange of rights associated with environmentally relevant items 202 may be provided. Referring to FIG. 26, at step 2602, a type of credit recognized by a market associated with an environmentally relevant action may be identified. Following this, at step 2604, a user interface may be provided to a user. The user may be able to access a rating relating to the quality of a particular environmentally relevant action that may qualify for the credit. In embodiments, the rating may be provided by a rating engine.

The platform 104 may include a performance assessment facility. The performance assessment facility may assess performance against a baseline. The performance assessment facility may determine the applicable baseline of emissions. The reduction of emissions relative to the baseline may initiate the creation or serialization of an environmentally relevant item 202. The performance assessment facility may track and report changes over time. The performance assessment facility may assess performance against a specified plan, set of requirements, policy and the like.

The platform 104 may include a market data facility. The market data facility may enable reporting and analysis. The market data facility may be used for data business applications. The market data facility may aggregate data relating to transactions performed in connection with the platform. The market data facility may provide data services to third parties. The market data facility may aggregate certain data for sale to third parties. In an embodiment, the market data facility may create an index. The third party may be a market participant, a researcher, a university, a government, policy maker or the like. The market data facility may allow for data to be licensed or sold to third parties. The market data facility may provide data relating certain environmentally relevant items 202 to certain related financial instruments, including, without limitation, securities and commodities, measures and the like. The market data facility may provide data relating certain environmentally relevant items 202 to any item to which the data has a relationship. In an embodiment, the relationship may be an elasticity. In an embodiment, the market data facility may relate the price of a given environmentally relevant item 202 to the price of oil. The market data facility may provide data or information though a user interface, via an RSS feed, on a subscription basis, as part of a dashboard 200, as a ticker or the like.

The platform 104 may include a billing engine. The billing engine may allow the platform 104 to generate invoices. The billing engine may be associated with tracking flows of money, such as wire transfers, checks and letters of credit, through the platform. The billing engine may track when transactions have been settled. The billing engine may track and charge for use of the platform. Fees may be assessed per transaction or per transfer. There may be a fee for creation of an environmentally relevant item 202. There may be a fee for retirement of an environmentally relevant item 202, such as to fulfill a regulatory requirement. Fees may be shared with brokers. There may be fees for account management, initiation, set-up, and maintenance. There may be fees for trading, brokerage, marketing and the like. There may be fees for verification and certification services. There may be fees for consulting and advisory services. There may be fees for market data services.

The platform 104 may include a retirement facility. The retirement facility may be an environmentally relevant item 202 retirement facility. The retirement facility may enable retirement of an environmentally relevant item 202 to meet regulatory requirements for a jurisdiction for a certain time period. The retirement facility may administer caps on and retirement of environmentally relevant items 202. The retirement facility may enable retirement of a certain amount of environmentally relevant items 202 overall. The retirement facility may enable retirement of environmentally relevant items 202 for voluntary and/or mandatory markets. The retirement facility may enable retirement of a certain percentage or number of environmentally relevant items 202 per trade. The retirement facility may enable retirement of environmentally relevant items 202 for a tax credit. The retirement facility may facilitate transfer of environmentally relevant items 202 to a non-profit organization. The retirement facility may enable retirement of environmentally relevant items 202 for utility companies to report compliance with their claims for voluntary green pricing programs. The retirement facility may enable retirement of environmentally relevant items 202 on behalf of one or more companies, individuals or other participants. The retirement facility may enable a broker or marketer of environmentally relevant items 202 to use sub-accounts to manage the retirement of environmentally relevant items 202 for multiple companies who are their clients and on whose behalf they manage and retire credits.

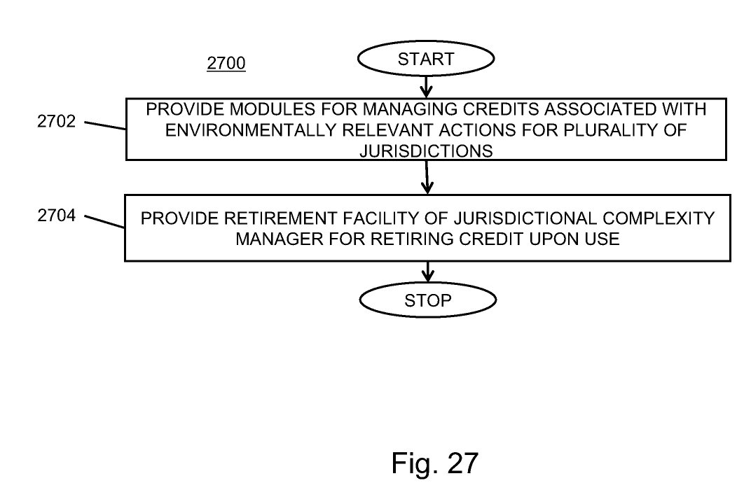

Referring to FIG. 27, a process 2700 for facilitating exchange of rights associated with environmentally relevant securities may be disclosed. In an example, environmentally relevant securities may be in the form of carbon credits, emission allowance, and the like. The process 2700 may begin at step 2702, where a module for managing credits associated with environmentally relevant actions for a plurality of jurisdictions may be provided. Following the above step 2702, at step 2704, a retirement facility, possibly associated with the jurisdictional complexity manager 122 may be provided for retiring the credit upon use.

The platform 104 may include an auction facility. The auction facility may allow for auctioning of environmentally relevant items 202. The auction facility may allow a jurisdiction to sell environmentally relevant items 202 to market participants in a jurisdiction. The auction facility may implement a set of auction rules with a prescribed workflow. In an embodiment, the auction facility may enable regulators to periodically sell greenhouse gas emissions allowances to buyers in a locality, sub-region, region, state or national market. In an embodiment, the auction facility may enable the processing of payments, checks, letters of credit, credit management and clearing. The auction facility may enable the offering of environmentally relevant items 202 for sale or exchange. The auction facility may enable the submission of bids. The auction facility may enable the reporting of awards to winning bidders, and may enable public reporting of auction results. The auction facility may automatically transfer emissions allowances or other environmentally relevant items 202 into a registry or market depository accounts of winning bidders or others. The auction facility may enable reverse auctions. In an embodiment, a participant may post a request for a certain environmentally relevant item 202 and other participants may submit bids to satisfy the request. In an embodiment, the auction facility may enable the auctioning of the initial allocation of the environmentally relevant items 202; for example, an auction by the government or regulatory agency granting or creating the credits.

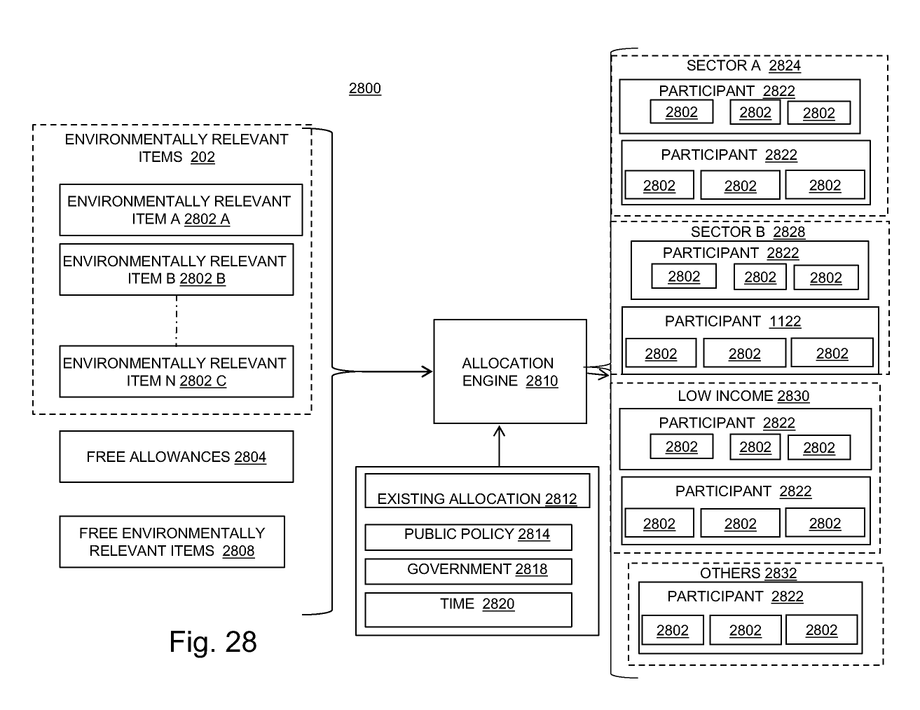

FIG. 28 depicts an allocation process 2800 performed by an allocation engine 2810. The allocation process may be performed on behalf of a government agency or agent. In embodiments, the platform 104 may include an allocation engine 2810. The allocation engine may allocate one or more environmentally relevant items 202. As shown in the FIG. 28, the environmentally relevant items may be environmentally relevant items 202, such as ‘A’ 2802, ‘B’ 2802, and the like for multiple participants 110. In addition to allocating environmentally relevant items 202, the allocation engine 2810 may allocate free allowances 2804 and free environmentally relevant items 2808 to various sectors, such as sector ‘A’ 2824 and sector ‘B’ 2828, low income groups 2830 and other similar groups or sectors 2832, as shown in the figure. In an example, participants 110 may be grouped into Sector ‘A’ 2824, Sector ‘B’ 2828, low income groups 2830 and other groups or sectors 2832. The sectors may be sectors of the economy. In an example, sector ‘A’ may be an agricultural sector, whereas sector ‘B’ may be a manufacturing sector that may be using environmentally relevant items 102. Further, each sector may include multiple participants 110 that are grouped based on a specific criteria as shown in the FIG. 28. For example, participants 110 in each of the sectors may be grouped based on usage of environmentally relevant items 202, type of environmentally relevant items 202, and the like.

In an aspect of the present invention, the allocation engine 2810 may consider the various parameters relevant to sector ‘A’ 2824, sector ‘B’ 2828, low income groups 2830, other sectors or groups 2832 before allocation environmentally relevant items 202, free allowances 2804 and free environmentally relevant items 202. In an example, the allocation engine 2810 may consider existing allocation 2812, public policy 2814, government 2818, and time 2820 factors before making an allocation and/or while making an allocation. The allocation engine 2810 may function to allocate one or more environmentally relevant items 202 among one or more participants 110 or other parties. In an embodiment, the allocation engine 2810 may be involved with the initial allocation of environmentally relevant items 202, such as by the government or regulatory agency granting or creating the credits. In an example, the allocation engine 2810 may determine an optimal allocation for the government to allocate a portion of the credits to lower income people (who may then sell the credits) to achieve a public policy goal. In another embodiment, the allocation engine 2810 may enable the management of the distribution of emissions allowances across multiple sectors of the economy, where each sector (power, manufacturing, agriculture, transportation and the like) may receive a different proportion of the overall number of emissions allowances. The allocation engine 2810 may also enable the management of the distribution of free allowances 2804 (such as those granted by the government at no cost) and the number or volume of auctioned or sold allowances during a particular time period.

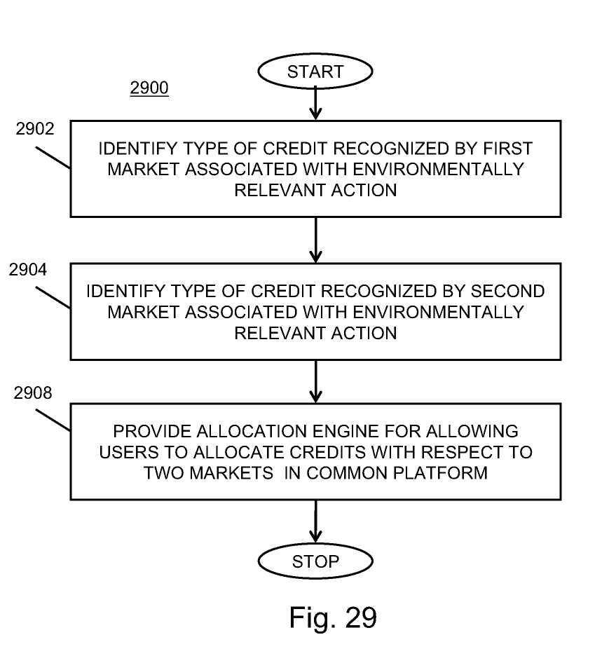

Referring to FIG. 29, an exemplary process 2900 is illustrated for facilitating exchange of rights associated with environmentally relevant items 202. The process 2900 may begin at step 2902, where a type of credit recognized by a first market may be identified. In embodiments, the type of credit may be carbon emission reduction credits, carbon credits and the like. In embodiments, the type of credit may be associated with an environmentally relevant action. In embodiments, the first market may include economic sectors, industrial markets, voluntary markets, mandatory markets, and the like. In embodiments, the environmentally relevant action may be the selling of environmentally relevant items 202. At step 2904, a type of credit recognized by a second market may be identified. In embodiments, the type of credit may be associated with an environmentally relevant action. In embodiments, the second type of credit may be carbon emission reduction credits, carbon credits, and the like. In embodiments, the environmentally relevant action may be selling of environmentally relevant items 202. In embodiments, the second market may include economic sectors, industrial markets, voluntary markets, mandatory markets, cross-environmentally relevant item markets, cross-jurisdiction markets, and the like. Finally at step 2908, the allocation engine 2810 for allowing users to allocate credits with respect to the two markets may be provided. In embodiments, the allocation engine 2810 may be provided in the common platform 104.

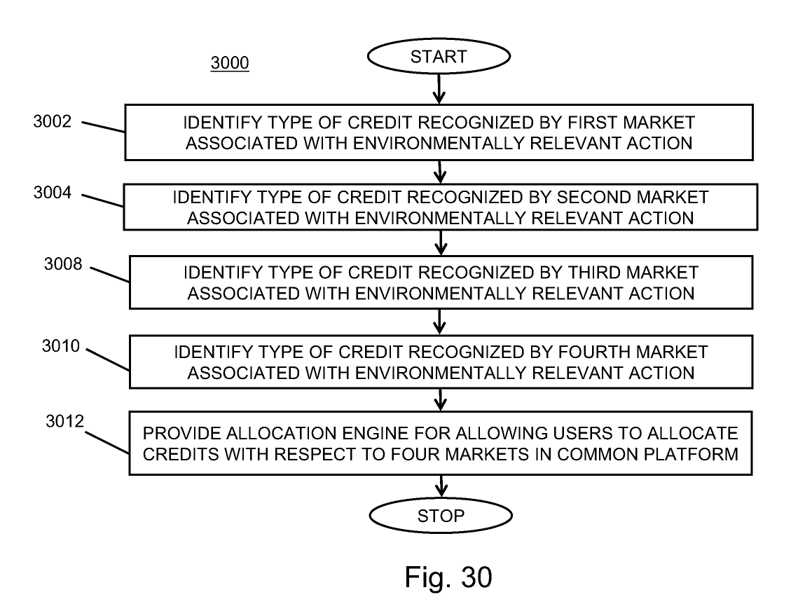

In embodiments, a process 3000 for facilitating exchange of rights associated with environmentally relevant items 202 may be provided. In an example, environmentally relevant items 202 may be in form of carbon credits, emission allowance, and the like. Referring to FIG. 30, at step 3002, a type of credit recognized by a first market associated with an environmentally relevant action may be identified. The first market may be a renewable energy credit market industrial market, voluntary market, regulatory market, and the like. For example, a carbon credit, recognized by a renewable energy credit market industrial market and associated with an environmental security, say emission allowance, may be identified. The environmentally relevant action may also be buying, selling, exchanging, and the like. For example, the carbon credit may be associated with buying of carbon credits in the market. Following this, at step 3004, another type of credit recognized by a second market associated with an environmentally relevant action may be identified. The second market may be industrial market, voluntary market, regulatory market and the like. For example, a residential emission reduction credit, recognized by a voluntary market and associated with an environmental security, may be identified. In embodiments, the environmental security may be approved by a jurisdiction such as a pollution control department of a country or some other type of jurisdiction. In embodiments, the second type of credit may be associated with a different type of environmentally relevant action. Similarly, at step 3008, yet another type of credit recognized by a third market associated with an environmentally relevant action may be identified. The third market may be industrial market, voluntary market, regulatory market, and the like. Further, at step 3010, yet another type of credit recognized by a fourth market associated with an environmentally relevant action may be identified. The process 3000 may further proceed to step 3012, where users may be allowed to allocate credits with respect to the four markets under a common platform 104 by providing the allocation engine 2810.

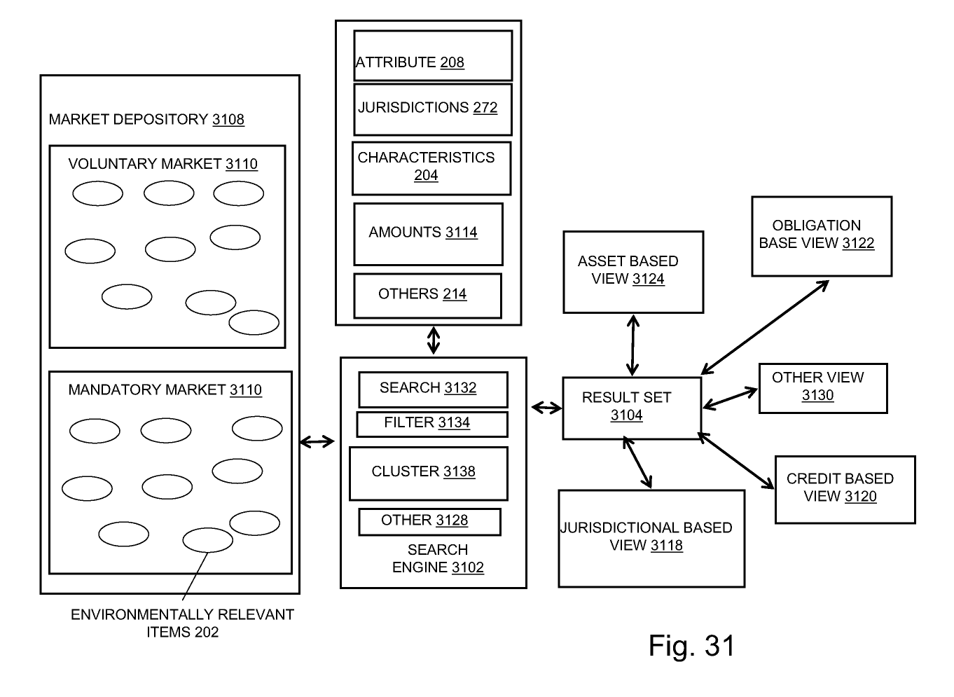

Referring to FIG. 31, the platform 104 may include a search engine 3102. The search engine 3102 may enable searching, filtering and/or clustering of environmentally relevant items 202 and attributes 208, jurisdictions 272, characteristics 204, amounts 3114, prices, and the like of environmentally relevant items 202. The search engine 3102 may enable search against an environmental market depository for attributes 208 associated with environmentally relevant items 202. The search engine 3102 may enable attribute-based search of environmentally relevant item markets 112, including both regulatory and voluntary markets 112. The search engine 3102 may allow for creation of various views of environmentally relevant items 202 and/or result set 3104. These views may include an asset based view 3124, obligation based view 3122, credit based view 3120, jurisdiction based view 3118, and some other type of view 3130. The search engine 3102 may filter the results based on certain attributes 208 or characteristics 204. In one particular embodiment, a search engine 3102 may be used to generate an inventory of what is available and pricing data for a particular environmentally relevant item 202 or group of environmentally relevant items 202. The search engine 3102 may be used to generate an inventory of what is available and pricing data for a particular environmentally relevant item 202 or group of environmentally relevant items 202. The search engine 3102 may be associated with a result set 3104. The result set 3104 may be obtained by running a query on the search engine 3102. The query may be related to market depository 3108 which may include a market such as voluntary market 3110 and a mandatory market 3112, and/or at least one other type of market, as shown in FIG. 31. In addition, the market depositories 3108 may include environmentally relevant items 202. The search engine 3102 may consider different parameters during the execution of query. For example, the different parameters may include attributes 208, jurisdictions 272, characteristics 204, amounts 3114, prices, and other types of parameters 214. In embodiments, the search engine 3102 may perform tasks such as search 3132, filter 3134, cluster 3138, and other types of actions 3128.

A protocol may define certain environmentally relevant items 202. A protocol may enable and/or facilitate the exchange of information concerning environmentally relevant items 202. A protocol may enable and/or facilitate the exchange of different environmentally relevant items 202 across different markets. In an embodiment, the markets may be for different environmentally relevant items 202. In an embodiment, the markets may be for different jurisdictions. A protocol may facilitate trading and transfer of environmentally relevant items 202. A protocol may facilitate creation and retirement of environmentally relevant items 202. A protocol may function in a manner similar to FIPS and SWIFT for financial markets. A protocol may allow a single object that is an environmentally relevant item 202, such as a REC. A protocol may be implemented or embodied in XML. A protocol may implement standard contract terms for each environmentally relevant item 202. In an embodiment a protocol may implement standard contract terms as applicable to RECs.

The platform 104 may include a content provision facility. The content provision facility may provide content to users. The content may be advertisements, news, bulletins, information concerning changes in environmental laws and regulations, information concerning pollution abatement and reduction technologies and the like. The content provision facility may target content based on the characteristics of a user. A relevant characteristic of a user may be the type of user, such as a generator, trader, polluter, and the like. Another relevant characteristic may be the trading behavior of the user and/or the portfolio of environmentally relevant items 202 held by the user.

The platform 104 may include an environmentally relevant item 202 serialization facility. The platform 104 may create new environmentally relevant items 202 based on input information, and may assign a unique identifier, such as an alphanumeric identifier or a serial number, to each environmentally relevant item 202 through a serialization facility. The serialization facility may ensure that double counting is avoided. The serialization facility may enable the unique environmentally relevant item 202 to be tracked from its origin to retirement, and maintain its unique transaction history and data in the system data record.

Participants 110, users, consumers and the like of the platform 104 may include generators, load serving entities, regulators, such as local, state, sub-regional, regional, federal, international and voluntary regulators, offset providers, marketers, traders, intermediaries, agents, brokers, clearinghouses, program administrators, verifiers, certifiers, industry associations, non-governmental agencies, governments, market operators, banks, hedge funds, financial institutions, universities, corporations, manufacturers, marketers, non-profit corporations, and the like.

The platform 104 may be relevant to industrial markets, such as electricity production, manufacturing, mining, agriculture, cement, transportation and the like. The platform 104 may be relevant to voluntary markets. In a voluntary market an environmentally relevant item 202, such as one relating to renewable energy, may be bought for public relations purposes. The platform 104 may enable or be a national system for voluntary environmental markets. In an embodiment, a participant may purchase green tags (RECs) using the platform 104 in order to claim that its energy use is carbon neutral and does not contribute to global warming. The platform 104 may also enable environmentally relevant items 202 to have geographic component. Voluntary market participants may want to have an environmental impact in certain regions, such as plant locations or regions with customers. The platform 104 may be relevant to mandatory markets. In a mandatory market regulations may require buying environmentally relevant items 202 or otherwise reducing emissions or the like. The platform 104 may integrate or link voluntary and mandatory markets. The platform 104 may enable interplay between voluntary and mandatory markets. In an embodiment, consumption in the voluntary market may increase the costs in the mandatory market as reflected in the platform. In an embodiment, production in voluntary market may decrease costs in mandatory market as reflected in the platform. As discussed herein, the platform 104 may enable cross-commodity environmental markets and cross-jurisdiction environmental markets (local, state, sub-regional, regional, national and international). The platform 104 may be a unified environmentally relevant item 202 market or market depository or registry.

The platform 104 may enable the creation of a national registry or market depository 3108 of environmentally relevant items 202. The platform 104 may link up the various local, state, sub-regional and regional markets into one national platform. The platform 104 may be used to reduce double counting and green-washing. The national registry or market depository 3108 may take into account mandatory and voluntary markets. The national registry or market depository 3108 may be hosted. The platform 104 may enable the creation of an international registry or market depository 3108 of environmentally relevant items 202. The platform 104 may link up the various local, state, sub-regional, regional, national and international registries, platforms and/or markets into one or more international registries, platforms and/or markets 112. In certain embodiments, the international registry or market depository 3108 may take into account mandatory and voluntary markets 112. In certain embodiments, the international registry or market depository 3108 may be hosted. The platform 104 may also enable optimization of a portfolio of environmentally relevant items 202. The platform 104 may enable management of pollution, emissions and the like, such as for government, regulators, corporations or the like.

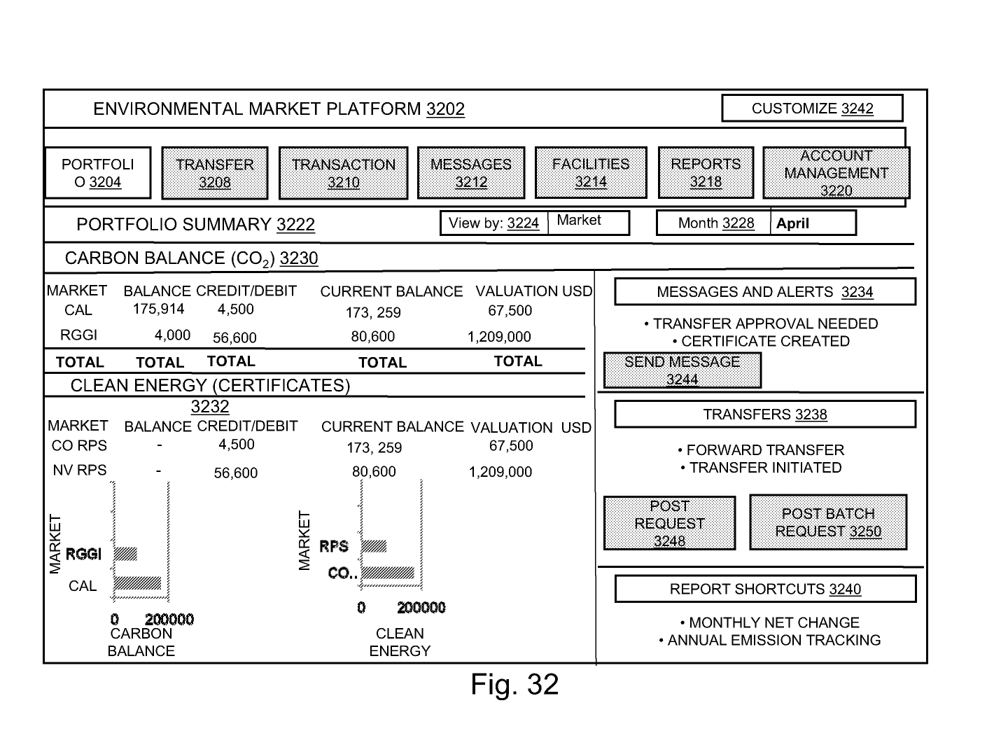

FIG. 32 depicts a user interface for the platform 104 or 3108, in accordance with an embodiment of the present invention. The user interface of the environmental market platform 104 or 3202 may provide information related to various environmentally relevant items. In an embodiment, the environmental market platform 3202 may be a depository or registry for RECs, EECs, CCs, carbon emission reduction credits and other environmentally relevant items. The user interface of the environmental market platform 3202 may be deployed at a corporate level to track environmentally relevant items, obligations or emissions for a firm. The user interface of the environmental market platform 3202 may be deployed for a broker, a marketer or a financial institution to track environmentally relevant items, obligations or emissions for multiple clients. The user interface of the environmental market platform 3202 may be used as a mechanism to link multiple localities, sub-regions, regions, states, or national markets or exchanges to track and transact environmentally relevant items. The user interface of the environmental market platform 3202 may be used as a single point of information and integration and as a custodial service by banks, brokers, marketers, and exchanges who may operate and transact environmentally relevant items across jurisdictions and markets. The user interface of the environmental market platform 3202 may be used to track, manage, and record intermediate transactions for environmentally relevant items across multiple registries.

Referring to FIG. 32, the user interface of the platform 104 or 3202 may show a depository and/or registry and may include multiple buttons or tabs (referred to as features), such as portfolio 3204, transfer 3208, transaction 3210, messages 3212, facilities 3214, reports 3218, account management 3220, and the like. Clicking on a feature may cause a different view or page of the user interface to be presented. The user interface in FIG. 32 shows the portfolio 3204 feature. Each user may have one more portfolios. The portfolio 3204 feature may display a portfolio summary 3222. The portfolio summary 3222 may be viewed by using drop-down menus or other menus, such as view by 3224 and month 3228. In an embodiment, the portfolio summary 3222 may be viewed by selecting the drop-down menus view by 3224 and month 3228. In addition, the selection of the month drop-down menu 3224 may be based on the selection of the view by drop-down menu 3224. For example, a user associated with the platform 104 may access his/her portfolio summary 3222 filtered on the basis of market for month of April. Further, those skilled in the art would appreciate that the summary may be displayed on the web page based on any other parameters as known in the art.

The environmental market platform 3202 may include a message and alerts section 3234, a transfers section 3228, a report shortcuts section 3240, and the like. The message and alerts section 3234 may provide updated information to the user based on his preferences relating to environmentally relevant items. In an example, the message and alerts section 3234 may provide information related to recent change in an emission allowance and the like. The messages and alerts section 3234 may include a send message feature 3244 for sending messages. Messages and alerts may also relate to notification of transfers of certificates into an account; notification of transfers of certificates out of an account; status of a transaction, such as the acceptance of a bid, or financial clearing of a transaction; status of the verification of certificates; an event reminder regarding the opening of a trading period, closing of a trading period, or due date for a compliance obligation and the like; and the like.

In addition, the user may be interested in selling, buying or exchanging environmentally items with other users. The transfers section 3228 may provide the user with the facility for exchanging, transferring and/or trading environmentally relevant items. Furthermore, a report shortcut 3240 may be provide in the user interface that may allow a user to view different reports corresponding to tracking and management of environmentally relevant items. In an example, the report shortcut 3240 may provide monthly net change of environmentally relevant items. In yet another example, the report shortcut 3240 may provide annual emission tracking of environmentally relevant items. Further, it may be appreciated by those skilled in the art that the portfolio summary 3222, messages and alerts 3234, transfers 3238, report shortcuts 3240 may be customized for display in any other alternate ways as known in the art without deviation from the scope of the invention.

Referring to FIG. 32, portfolio summary 3222 may display the statistics and graphs for various environmentally relevant items. In an example, the portfolio summary 3222 may include various statistics relating to carbon balance 3230. The statistics may include market, balance, credit/debit, current balance and valuation in USD in tabular form as shown in FIG. 32. Further, in this example, a graph may be provided between markets and carbon balance. Similarly, in this example, the portfolio may further include clean energy certificates 3232 statistics and a corresponding graph between markets and clean energy. Further, those skilled in the art would appreciate that statistics and graph may be displayed in any other alternate way as known in the art. In embodiments, the user interface for an environmental market platform 3202 may include a customize feature 3242 for customization of the interface. In an example, the web page may be customized to include one or more elements and/or features in order to customize the user interface of environmental market platform 3202. In an embodiment the interface may be branded.

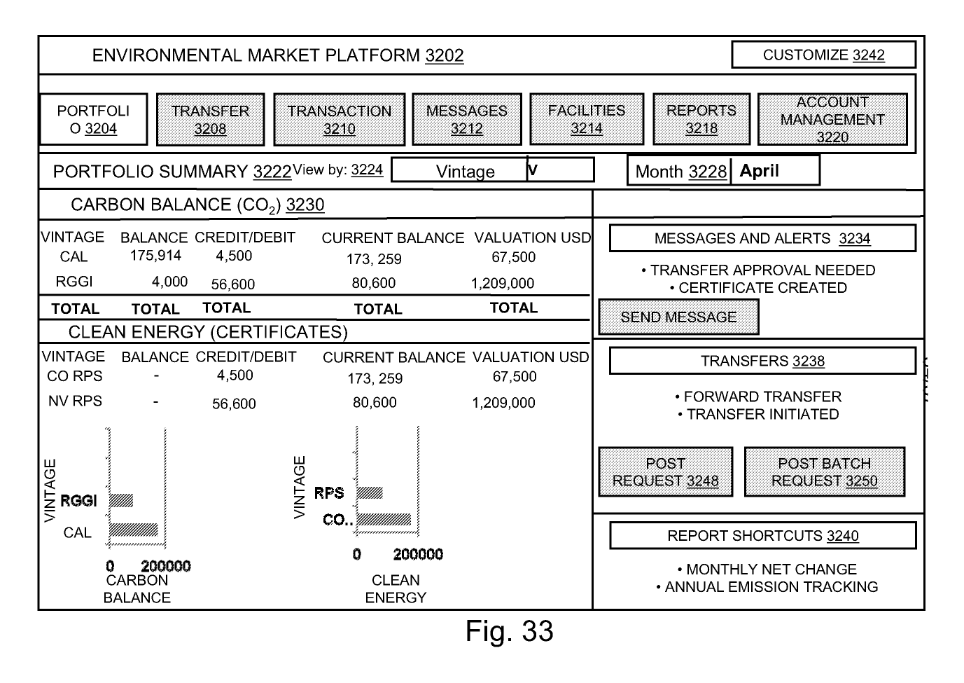

Referring to FIG. 33, in an alternate embodiment, the portfolio summary 3222 may be viewed by selecting vintage in the “view by” drop-down menu 3302. Further, a month April may be selected in the drop-down menu month 3228. As shown in FIG. 33, the statistics corresponding to carbon balance 3230 may be displayed in the web page in the user interface. The carbon balance 3230 may include vintage, balance, credit/debit, current balance valuation, and the like. Additionally, graphs corresponding to the selection vintage and the carbon balance 3230 may be displayed as shown in FIG. 32. Similarly, statistics relating to renewable energy or clean energy 3232 may be displayed in the web page. In addition, graphs for the selection vintage 3302 and clean energy 3224 may be displayed. In an example, the graph showing clean energy 3232 and vintage may be a bar graph, a pie chart, a histogram and the like.

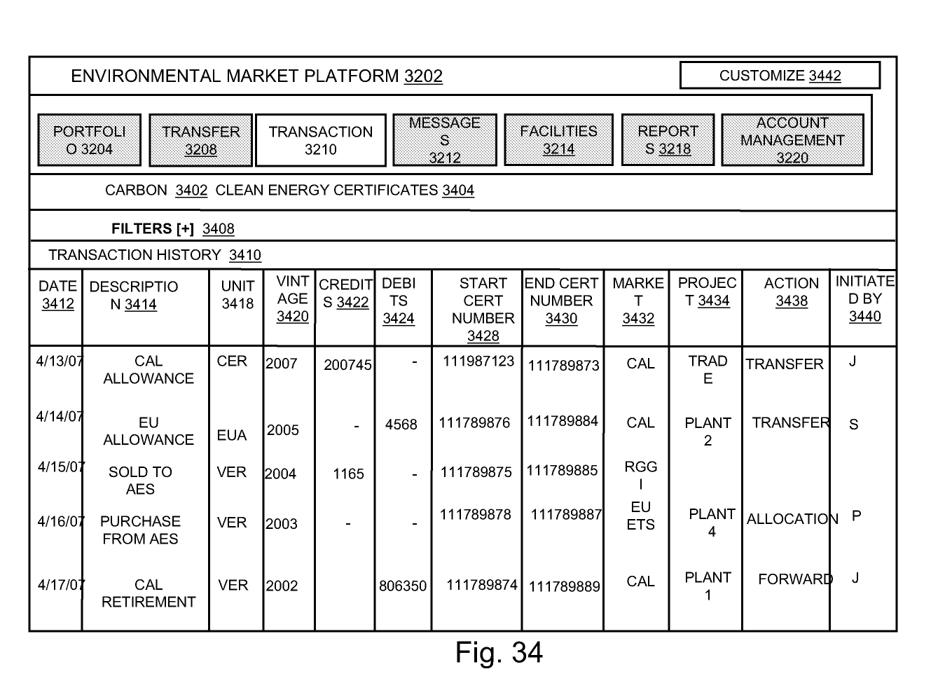

Referring to FIG. 34, a transaction feature 3210 may be selected in environmental market platform 3202 in the user interface. The transaction feature 3204 may further provide additional features such as a carbon feature 3402 and a clean energy certificates feature 3404 as shown in the FIG. 34. In an example, the carbon feature 3402 may be selected. In addition, a filter 3408 may be provided in the web page that may allow customization of transaction history 3410 based on the filtering criteria. In an example, the default parameters for the transaction history 3410 may include a date 3412, description 3414, vintage 3302, credits 3420, debits 3422, start certificate number, 3424, end certificate number 3428, market 3430, project 3432, action 3438, initiated by 3438 and the like as shown in the FIG. 34. Further, the table showing transaction history 3410 may be customized in any other way as known in the art. In an example, the transaction history 3410 table may be shown in a tabular form, a form showing only one transaction and the like.

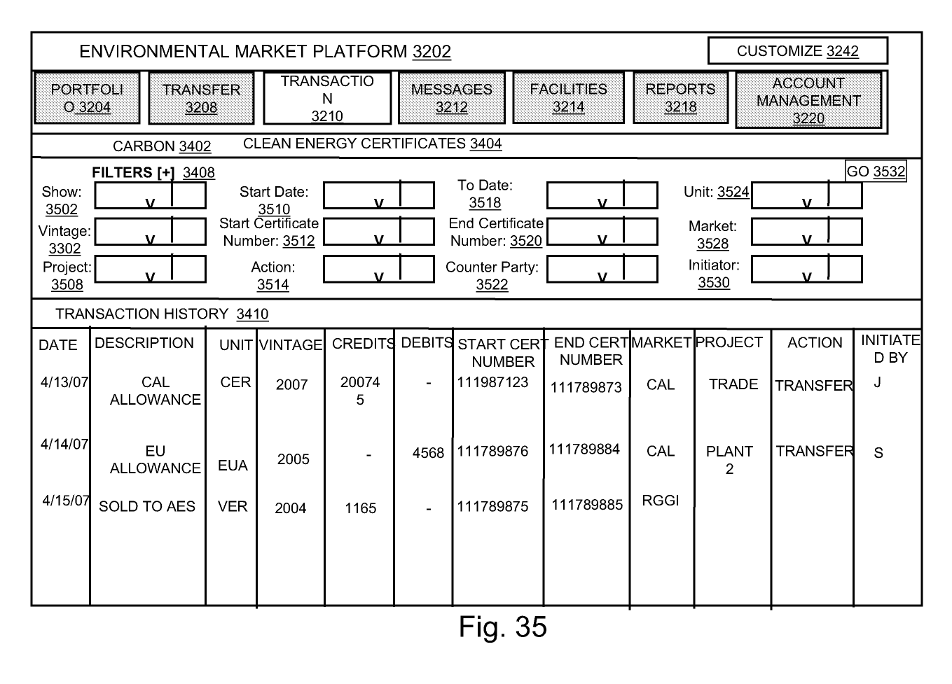

Referring to FIG. 35, the transaction feature 3210 may be selected in an environmental market platform 3202 in the user interface. The transaction feature 3210 may further include additional features, such as features for carbon 3402 and clean energy certificates 3232 respectively as described in the FIG. 34. Further, those skilled in the art may note that the transaction feature 3210 may include other features not shown in FIG. 35 or may be customized an alternate way. The web page may also include filtering of data based on different parameters. In an embodiment, the filtering of data may be based on show 3502, vintage 3302, project 3508 start date 3510, start certificate number 3512, action 3514, to date 3516, end certificate number 3520, counter-party 3522, unit 3524, market 3528, initiator 3520 and the like. In an example, as shown in a web page, a drop down box may be provided to show 3502 and to allow selection of data for performing filtration of transaction history 3410 to be displayed in the web page. Further, a feature may be provided for filtering data corresponding to the inputs made in the text box against each parameter. In an example, the parameter may be projects, action and the like and may be executed by a “Go” feature 3532. In this embodiment, the last portion of the web page of the transaction feature may show the “Transaction History” associated with the filtered data selected. The transaction history may show the results corresponding to the filtered data after execution of the query based on the selected parameters in the filtered text boxes. Further, those skilled in the art may appreciate that the web page corresponding to the transaction feature may be customized alternate ways as known in the art.

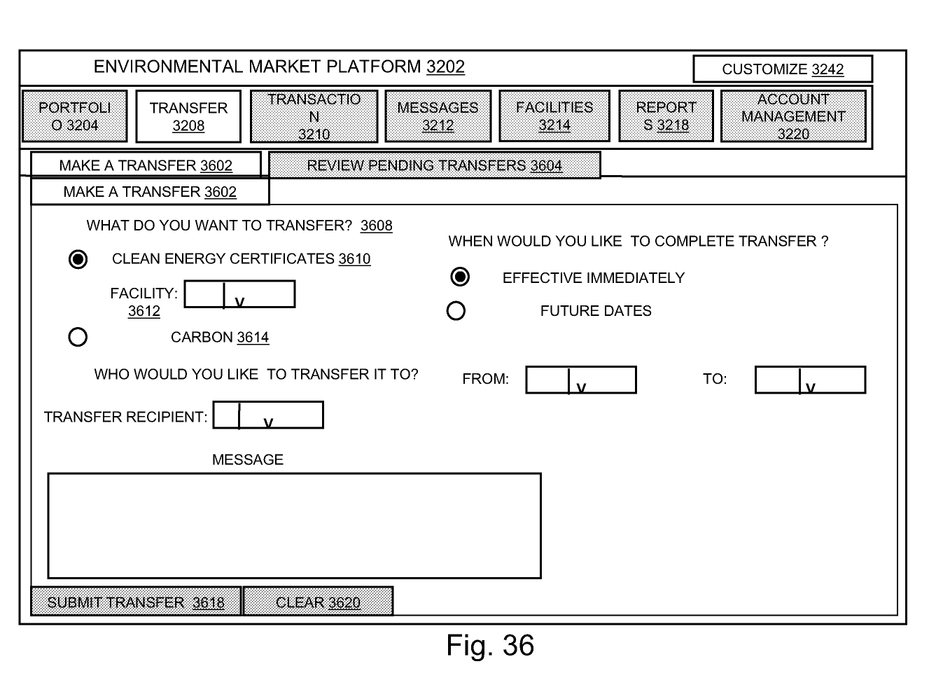

Referring to FIG. 36, a transfer feature 3602 may be selected in the user interface of the environmental market platform 3202. In an embodiment, the transfer feature 3602 may provide two options, “Make a Transfer” 3602 and “Review Pending Transfers” 3604. As shown in FIG. 36, the Make a Transfer feature 3602 may be selected. In an embodiment, the make a transfer feature 3602 may include questions and corresponding selection buttons. In an example, the make a transfer feature 3602 may show a question “what you want to transfer” 3608 and may provide a set of radio buttons corresponding to clean energy certificates 3610 and carbon (tCO₂) 3614. Further, in this example a drop down menu labeled as “facility” 3612 may be provided for conducting search availability related to the selection made in the drop down menu. Similarly, make a transfer feature 3602 may provide other question including “What you would like to transfer it to?”, “How much would you like to transfer?”, “When would you like to complete the transfer?” and the like as shown in the FIG. 36. Further, the web page may be customized to include other questions and/or corresponding radio buttons, combo boxes, text boxes, labels option buttons and the like for providing answer to these questions. In this example, a message textbox may be provided for inputting any message for submission to the platform. Additionally, a “Submit Transfer” 3618 feature and a “clear” 3620 feature may be provided. The “Submit Transfer” that allows the selection made in the web page to be submitted to the platform from the user interface. In addition, by pressing the “clear feature” the user can clear all the selections chosen by him/her on the web page.

The user interface may also contain various screens relating to facilities. The facilities screens may present a site-level summary of assets (such as credits or certificates) and liabilities (such as state, regional or federal obligations). The facilities screens may be similar in appearance to the portfolio-related views, except filtered for those aspects pertaining to a site or facility. The user interface may also contain various screens relating to reports. Reports may include the number and types of certificates created, transferred, purchased, sold, or retired, the value of a position, such as mark to market for quarterly reporting purposes, the number of certificates short or long, relative to compliance obligations and the like. The user interface may also contain various screens related to account management.

The platform 104 may be architected in many different ways. The platform 104 may be deployed in a web-based architecture. In one embodiment, the deployment may be browser-based with no downloadable software required. In another embodiment, the deployment may use client-side software. In another embodiment, the platform 104 may comprise a web-based carbon registry for carbon commodities, including credits/offsets, allowances, and emissions tracking. The platform 104 may be deployed in a services oriented architecture. The platform 104 may be deployed on a network. The platform 104 may be hosted. The platform 104 may include a user interface. The user interface may include a dashboard 200 as described herein. The platform 104 may include or be deployed using an application server. The platform 104 may include or be deployed using data processing functionality. The platform 104 may include or utilize compression technology. The platform 104 may include or utilize data compression methods in relation to environmentally relevant items 202, renewable energy certificates, energy efficiency certificates, carbon commodities or other environmental commodities, securities or financial instruments. The data storage and compression methods enable the efficient storage and management of greater than hundreds of millions of certificates and related transactions over years. The platform 104 may include 24×7 operations support and monitoring. The platform 104 may include a data archive and audit trail. The platform 104 may include functionality for security, conditional access, role based access, and logging. The platform 104 may include functionality for encryption and authentication. The platform 104 may grant different levels of access to different classes of user. In an embodiment, a program administrator may have full access to the platform 104 with full view of accounts and may be permitted to open and/or close trading periods. In contrast, a trader may only have access to her portfolio and data regarding certain classes of environmentally relevant items 202.

The data utilized and generated by the platform 104 may be calculated, measured, historical, real-time and the like. The data utilized and generated by may also include data regarding transactions completed using the platform. The data utilized by the platform 104 may come from various sources. These sources may include meters (such as meters located at a generator which provide production information), file transfers, manual entry (including manual entry by independent third parties), the platform 104 itself, existing databases, local, state, sub-regional, regional, national and international sources, other platforms and the like.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. A method for facilitating exchange of rights associated with environmentally relevant items, comprising:
identifying a first environmentally relevant item;
identifying a second environmentally relevant item; and
providing a software-based module for a market oversight facility by which at least one user may oversee at least one activity relevant to the first and second environmentally relevant items.

2. The method of claim 1, wherein the first and second environmentally relevant items relate to the same jurisdiction.

3. The method of claim 1, wherein the first and second environmentally relevant items relate to different jurisdictions.

4. The method of claim 1, wherein the first and second environmentally relevant items are of different types.

5. The method of claim 1, wherein the first and second environmentally relevant items are of the same type.

6. The method of claim 1, wherein the first and second environmentally relevant items relate to different underlying environmental attributes.

7. The method of claim 1, wherein the first and second environmentally relevant items relate to the same underlying environmental attribute.

8. The method of claim 1, wherein the at least one user is a regulator.

9. The method of claim 8, wherein the user uses the market oversight facility to assess compliance with at least one law, rule and regulation.

10. The method of claim 8, wherein the user uses the market oversight facility to enforce compliance with at least one law, rule and regulation.

11. The method of claim 1, wherein the at least one user is a governmental user.

12. The method of claim 8, wherein the user uses the market oversight facility to assess compliance with at least one law, rule and regulation.

13. The method of claim 8, wherein the user uses the market oversight facility to enforce compliance with at least one law, rule and regulation.

14-18. (canceled)

19. The method of claim 1, wherein the module considers a derivative environmentally relevant item based on the environmentally relevant items.

20. The method of claim 1, wherein the module provides a user interface.

21. The method of claim 20, wherein the user interface contains a dashboard that display information relating to at least one environmentally relevant item.

22. (canceled)

23. The method of claim 20, wherein the user interface facilitates tracking the application of environmentally relevant items relating to an activity.

24. (canceled)

25. The method of claim 20, wherein the user interface is a dashboard allowing for tracking the impact of various environmentally relevant actions.

26-40. (canceled)

41. The method of claim 1 further comprising providing a software-based module for determining compliance.

42. (canceled)

43. The method of claim 1 further comprising providing a software-based module for verifying attributes of at least one environmentally relevant item.

44. (canceled)

45. The method of claim 1 further comprising providing a software-based allocation engine module.

46. The method of claim 1 further comprising providing a software-based module for reporting.

47. The method of claim 1 further comprising providing a software-based module for forensic reporting.

48. The method of claim 1 further comprising providing a software-based module for auditing.

49. The method of claim 1 further comprising providing a software-based module for auctioning at least one environmentally relevant item.

50. The method of claim 1 further comprising providing a software-based module for trading at least one environmentally relevant item.

51-53. (canceled)

54. The method of claim 1 further comprising providing a credit and clearing engine.

55. (canceled)

56. The method of claim 1 further comprising providing a work flow manager.

57. The method of claim 1 further comprising providing a buying network.

58-59. (canceled)

60. The method of claim 1 further comprising providing a market data facility.

61. The method of claim 1 further comprising providing a billing engine.

62. The method of claim 1 further comprising providing a content provision facility.

63. The method of claim 1 further comprising providing an environmentally relevant item serialization facility.

64-66. (canceled)

67. The method of claim 1, wherein at least one of the environmentally relevant items is specified by a protocol.

68. The method of claim 1, wherein each environmentally relevant item is specified by a different protocol.

69. The method of claim 1, wherein at least one of the environmentally relevant items relates to carbon.

70. The method of claim 1, wherein at least one of the environmentally relevant items relates to energy efficiency.

71. The method of claim 1, wherein at least one of the environmentally relevant items relates to pollution reduction.

72. The method of claim 1, wherein at least one of the environmentally relevant items relates to renewable energy.

73. (canceled)

74. A method for facilitating exchange of rights associated with environmentally relevant items, comprising:
identifying an environmentally relevant item relating to a first jurisdiction associated with an environmentally relevant action;
identifying an environmentally relevant item relating to a second jurisdiction associated with an environmentally relevant action; and
providing a software-based module for a market oversight facility by which at least one user may oversee at least one activity relevant to the first and second environmentally relevant items.

75-90. (canceled)

91. The method of claim 74, wherein the at least one user uses the market oversight facility to assess compliance with at least one law, rule and regulation.

92. The method of claim 74, wherein the at least one user uses the market oversight facility to enforce compliance with at least one law, rule and regulation.

93-115. (canceled)

116. The method of claim 74 further comprising providing a software-based module for determining compliance.

117. The method of claim 116, wherein compliance is determined with respect to at least one law, rule or regulation.

118. The method of claim 74 further comprising providing a software-based module for verifying attributes of at least one environmentally relevant item.

119-120. (canceled)

121. The method of claim 74 further comprising providing a software-based module for reporting.

122-148. (canceled)

149. A method for facilitating exchange of rights associated with environmentally relevant items, comprising:
identifying a first type of environmentally relevant item associated with an environmentally relevant action;
identifying a second type of environmentally relevant item associated with an environmentally relevant action; and
providing a software-based module for a market oversight facility by which at least one user may oversee at least one activity relevant to the first and second environmentally relevant items.

150-155. (canceled)

156. The method of claim 149, wherein the environmentally relevant actions are the same.

157. The method of claim 149, wherein the environmentally relevant actions are different.

158-167. (canceled)

168. The method of claim 149, wherein the module considers an exchange rate between the environmentally relevant items.

169. The method of claim 149, wherein the module considers a derivative environmentally relevant item based on the environmentally relevant items.

170. The method of claim 149, wherein the module provides a user interface.

171. The method of claim 170, wherein the user interface contains a dashboard that display information relating to at least one environmentally relevant item.

172-223. (canceled)

224. A method for facilitating exchange of rights associated with environmentally relevant items, comprising:
identifying a type of environmentally relevant item recognized by a first market associated with an environmentally relevant action;
identifying a type of environmentally relevant item recognized by a second market associated with an environmentally relevant action; and
in a common platform, allowing at least one user to oversee at least one activity in the first market and the second market.

225-240. (canceled)

241. A method for facilitating exchange of rights associated with environmentally relevant items, comprising:
providing a module for overseeing environmentally relevant items associated with environmentally relevant actions, the module operating on a computer platform.

242-249. (canceled)

250. The method of claim 241, wherein the module provides a user interface.

251-255. (canceled)

256. The method of claim 241, wherein the environmentally relevant items reside in a single depository.

257. The method of claim 256, wherein the depository includes environmentally relevant items of different types.

258. The method of claim 256, wherein the depository includes environmentally relevant items relating to different jurisdictions.

259-272. (canceled)

273. The method of claim 241 further comprising providing a software-based module for verifying attributes of at least one environmentally relevant item.

274-275. (canceled)

276. The method of claim 241 further comprising providing a software-based module for reporting.

277-303. (canceled)

304. A method for facilitating exchange of rights associated with environmentally relevant items, comprising:
identifying a type of credit as an environmentally relevant item recognized by a first market associated with an environmentally relevant action;
identifying a type of credit as an environmentally relevant item recognized by a second market associated with an environmentally relevant action;
identifying a type of credit as an environmentally relevant item recognized by a third market associated with an environmentally relevant action;
identifying a type of credit as an environmentally relevant item recognized by a fourth market associated with an environmentally relevant action; and
in a common platform, allowing at least one user to oversee at least one activity in all four markets, wherein the markets are selected from the group consisting of a renewable energy credit market, an energy efficiency credit market, a pollution reduction market and a carbon credit market.

305-314. (canceled)

315. The method of claim 304, wherein the at least one user uses the market oversight facility to assess compliance with at least one law, rule and regulation.

316. The method of claim 304, wherein the at least one user uses the market oversight facility to enforce compliance with at least one law, rule and regulation.

317. The method of claim 304, wherein the oversight is provided using a software-based module.

318-499. (canceled)
